(19) United States
(12) Patent Application Publication
(10) Pub. No.: US 2025/0016689 A1
(43) Pub. Date: Jan. 9, 2025

(54) TRANSMIT ENERGY REPORT FOR TIME AVERAGED TRANSMISSION POWER TRANSMISSION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Xiaoxia ZHANG, San Diego, CA (US); Kazuki TAKEDA, Minato-ku (JP)

(21) Appl. No.: 18/706,361

(22) PCT Filed: Dec. 7, 2021
(86) PCT No.: PCT/CN2021/135960

§ 371 Date: Apr. 30, 2024

(51) Int. Cl. H04W 52/22; H04L 5/00; H04W 52/36; H04W 72/11; H04W 72/1268; H04W 72/231

(52) U.S. Cl. CPC H04W 52/223; H04L 5/0051; H04W 52/367; H04W 72/11; H04W 72/1268; H04W 72/231

(57) ABSTRACT

The apparatus may be configured to calculate a predicted transmission power associated with one or more future transmissions within a first time period. The apparatus may further be configured to transmit, to a base station, a TER regarding the predicted transmission power. The apparatus may be configured to report at least one quantity to a base station, the at least one quantity indicating for the UE to adjust an UL transmission characteristic. The apparatus may further be configured to adjust, based on the at least one quantity reported to the base station indicating for the UE to adjust the UL transmission characteristic and a set of rules associated with the UL transmission, at least one parameter associated with the UL transmission.

### TECHNICAL FIELD

The present disclosure relates generally to communication systems, and more particularly, to reporting and adjusting transmission power to comply with radio frequency exposure limits by wireless devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may be configured to calculate a predicted transmission power associated with one or more future transmissions within a first time period. The apparatus may further be configured to transmit, to a base station, a TER regarding the predicted transmission power.

In an aspect of the disclosure, a method, a computer-readable medium, and an apparatus are provided for wireless communication at a UE. The apparatus may be configured to report at least one quantity to a base station, the at least one quantity indicating for the UE to adjust an UL transmission characteristic, where the at least one quantity indicates for the UE to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to a maximum permissible exposure event. The apparatus may further be configured to adjust, based on the at least one quantity reported to the base station indicating for the UE to adjust the UL transmission characteristic and a set of rules associated with the UL transmission, at least one parameter associated with the UL transmission.

In an aspect of the disclosure, a method, a computer-readable medium, and an apparatus are provided for wireless communication at a base station. The apparatus may be configured to receive at least one quantity reported by a UE to adjust an UL transmission characteristic, where the at least one quantity indicates to adjust the UL transmission characteristic based on at least one of an increase of a reported quantity that is greater than a first threshold increase value, a decrease of the reported quantity that is greater than a second threshold decrease, the reported quantity being larger than a third threshold value, the reported quantity being lower than a fourth threshold value, or the reported quantity being related to a maximum permissible exposure event. The apparatus may further be configured to adjust at least one parameter associated with the UL transmission, the adjusting being based on the at least one quantity reported by the UE indicates for the UE to adjust the UL transmission characteristic and a set of rules associated with the UL transmission.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network in accordance with various aspects of the present disclosure.

FIG. 2A is a diagram illustrating an example of a first subframe within a 5G NR frame structure in accordance with various aspects of the present disclosure.

FIG. 2B is a diagram illustrating an example of DL channels within a 5G NR subframe in accordance with various aspects of the present disclosure.

FIG. 2C is a diagram illustrating an example of a second subframe within a 5G NR frame structure in accordance with various aspects of the present disclosure.

FIG. 2D is a diagram illustrating an example of UL channels within a 5G NR subframe in accordance with various aspects of the present disclosure.

FIG. 3 is a block diagram of a base station in communication with a UE in an access network in accordance with various aspects of the present disclosure.

FIG. 4 illustrates a power density limit over a four second time period in accordance with various aspects of the present disclosure.

FIG. 5 is a diagram illustrating a set of data and control transmissions associated with dynamic power control associated with RF exposure limits in accordance with various aspects of the present disclosure.

FIG. 6 is a set of diagrams illustrating a dynamic power (e.g., transmission power) limit that takes advantage of time-averaging and a power reservation (e.g., a reserved power) in accordance with various aspects of the present disclosure.

FIG. 7 is a call flow diagram for a method of wireless communication in accordance with various aspects of the present disclosure.

FIG. 8 illustrates a first and second method of calculating a reported value in accordance with various aspects of the present disclosure.

FIG. 9 is a diagram illustrating an example of dropping a low-priority transmission based on a TER in accordance with various aspects of the present disclosure.

FIG. 10A is a diagram illustrating a set of multiple time periods of equal durations or lengths for reporting in a TER in accordance with various aspects of the present disclosure.

FIG. 10B is a diagram illustrating a set of multiple time periods of unequal durations or lengths for reporting in a TER in accordance with various aspects of the present disclosure.

FIG. 11 is a flowchart of a method of wireless communication in accordance with various aspects of the present disclosure.

FIG. 12 is a flowchart of a method of wireless communication in accordance with various aspects of the present disclosure.

FIG. 13 is a flowchart of a method of wireless communication in accordance with various aspects of the present disclosure.

FIG. 14 is a flowchart of a method of wireless communication in accordance with various aspects of the present disclosure.

FIG. 15 is a flowchart of a method of wireless communication in accordance with various aspects of the present disclosure.

FIG. 16 is a diagram illustrating an example of a hardware implementation for an apparatus in accordance with various aspects of the present disclosure.

FIG. 17 is a diagram illustrating an example of a hardware implementation for an apparatus in accordance with various aspects of the present disclosure.

FIG. 18 is a diagram of an example neural network component comprised in a UE in accordance with various aspects of the present disclosure.

### DETAILED DESCRIPTION

In some aspects of wireless communication, a historical power consumption of a UE or a remaining power budget for the UE over a time window are unavailable at a base station. Without such information at the base station, performance degradation or greater overhead may occur. For example, without such information the base station may schedule the UE with a lower modulation and coding scheme (MCS), fewer resource blocks (RBs), more repetitions, more resource elements (REs) for channel state information (CSI) multiplexed with data based on a lower power headroom report, which may not accurately reflect the current power budget of the UE. The more conservative scheduling by the base station may degrade performance for the UE. In order to improve performance, the base station may reconfigure or reactivate a grant, which leads to additional overhead. As an example, the performance degradation and greater overhead may be problematic for communication with the UE based on configured grant physical uplink shared channel (CG-PUSCH) and/or a P-CSI report. Aspects presented herein provide for enhancing information reported from a UE to a base station, which can be used to improve performance related to CG-PUSCH and/or P-CSI report through more accurate scheduling for the UE and may further reduce overhead associated with the CG-PUSCH and P-CSI. Additional aspects enable the UE to alter transmission parameters for periodic or SPS uplink traffic in response to criteria being met regarding a reported energy or an average transmission power. The adjustment by the UE may help to reduce control overhead for the base station to reconfigure or activate a configuration for periodic or SPS uplink traffic.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

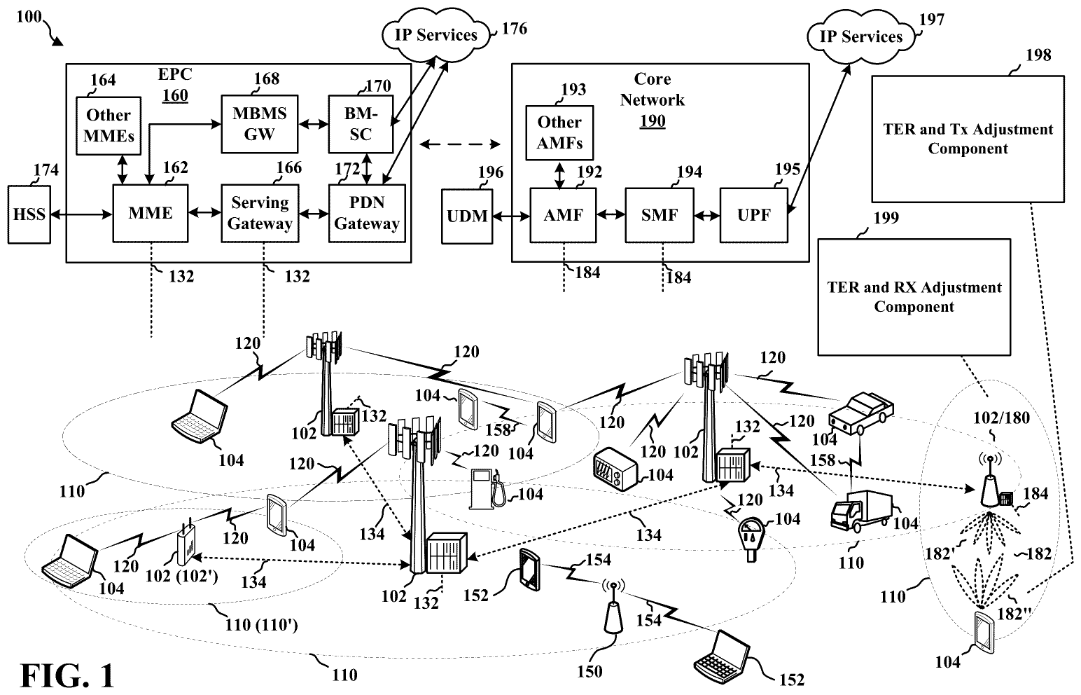

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured with a TER and transmission (Tx) adjustment component 198 that may be configured to calculate a predicted transmission power associated with one or more future transmissions within a first time period. The TER and transmission (Tx) adjustment component 198 may further be configured to transmit, to a base station, a TER regarding the predicted transmission power. In some aspects, the TER and transmission (Tx) adjustment component 198 may be configured to report at least one quantity to a base station, the at least one quantity indicating for the UE to adjust an UL transmission characteristic, where the at least one quantity indicates for the UE to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to a maximum permissible exposure event. The TER and transmission (Tx) adjustment component 198 may further be configured to adjust, based on the at least one quantity reported to the base station indicating for the UE to adjust the UL transmission characteristic and a set of rules associated with the UL transmission, at least one parameter associated with the UL transmission.

In certain aspects, the base station 180 may be configured to include a TER and reception (Rx) adjustment component 199 that may be configured to receive, from a UE, a TER regarding a predicted transmission power associated with one or more future transmissions within a first time period. The TER and reception (Rx) adjustment component 199 may further be configured to indicate a transmission power to the UE based on the TER received from the UE. The TER and reception (Rx) adjustment component 199 may be configured to receive at least one quantity reported by a UE to adjust an UL transmission characteristic, where the at least one quantity indicates to adjust the UL transmission characteristic based on at least one of an increase of a reported quantity that is greater than a first threshold increase value, a decrease of the reported quantity that is greater than a second threshold decrease, the reported quantity being larger than a third threshold value, the reported quantity being lower than a fourth threshold value, or the reported quantity being related to a maximum permissible exposure event. The TER and reception (Rx) adjustment component 199 may further be configured to adjust at least one parameter associated with the UL transmission, the adjusting being based on the at least one quantity reported by the UE indicates for the UE to adjust the UL transmission characteristic and a set of rules associated with the UL transmission. Although the following description may be focused on 5G NR, the concepts described herein may be applicable to other similar areas, such as LTE, LTE-A, CDMA, GSM, and other wireless technologies.

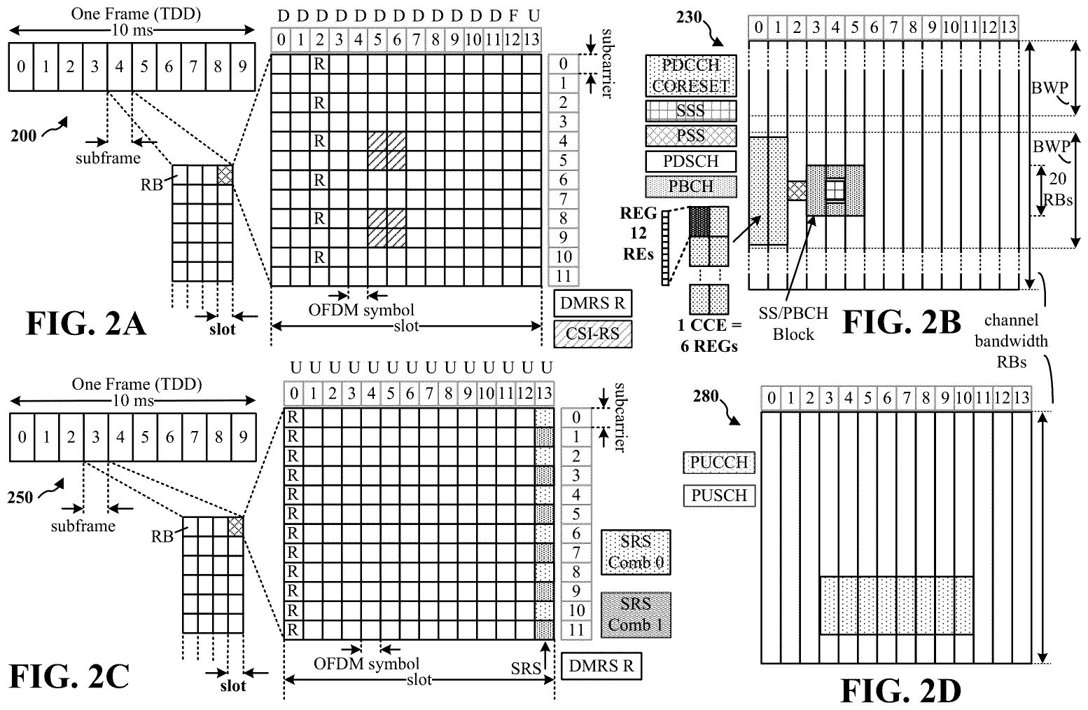

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ} *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

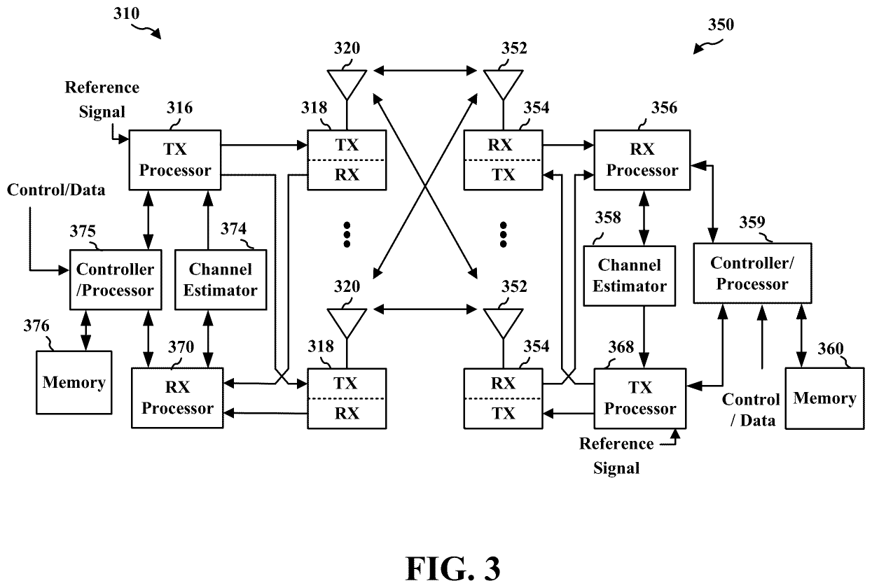

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter at RX/TX 318. Each transmitter at RX/TX 318 may modulate a radio frequency (RF) carrier with a respective spatial stream for transmission.

At the UE 350, each receiver at RX/TX 354 receives a signal through its respective antenna 352. Each receiver at RX/TX 354 recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters at RX/TX 354 Each transmitter at RX/TX 354 may modulate an RF carrier with a respective spatial stream for transmission.

The UL transmission is processed at the base station 310 in a manner similar to that described in connection with the receiver function at the UE 350. Each receiver at RX/TX 318 receives a signal through its respective antenna 320. Each receiver at RX/TX 318 recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

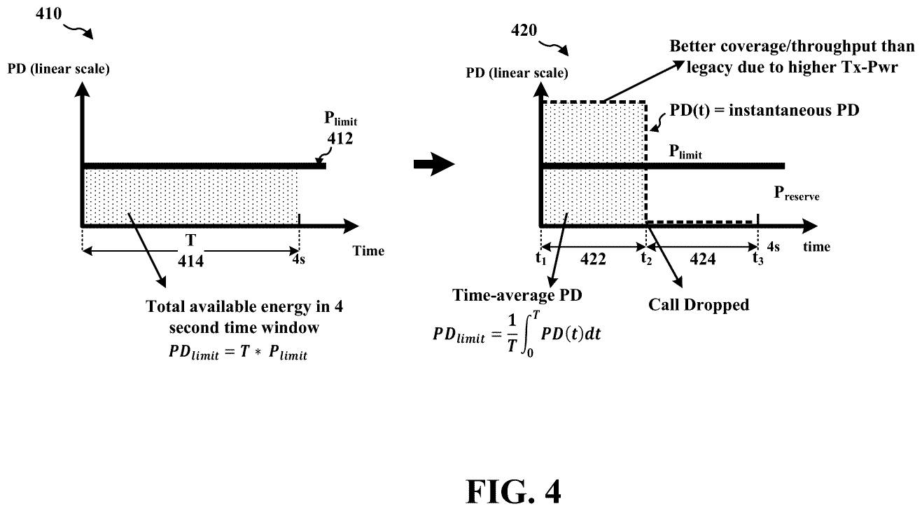

In some aspects of wireless communication, wireless devices that are able to perform time averaging of transmission power to adhere to radio frequency (RF) exposure limits for a defined time window. A wireless device may use a power back off look up table or time averaging (e.g., where a maximum peak power limit effectively becomes a maximum average power limit). FIG. 4 illustrates a power density (PD) limit (PDₗᵢₘᵢₜ) over a four second time period (T) 414. A total PDₗᵢₘᵢₜ may be defined by a maximum PD multiplied by a time period. Diagram 410 illustrates a Pₗᵢₘᵢₜ 412 without time averaged transmission power transmission, while diagram 420 illustrates with time averaged transmission power transmission. Diagram 410 illustrates a constant power limit (Pₗᵢₘᵢₜ) 412 that is used to ensure adherence to the RF exposure limits without dynamic adjustment of a power density based on time-averaging. In diagram 410 the PDₗᵢₘᵢₜ may be met by applying the constant power limit (Pₗᵢₘᵢₜ) 412 such that the PDₗᵢₘᵢₜ is calculated by multiplying a time period (T) 414 by the constant power limit (Pₗᵢₘᵢₜ) 412 (e.g., T*Pₗᵢₘᵢₜ).

Diagram 420 illustrates a dynamic power limit that takes advantage of time-averaging to improve coverage and/or throughput by increasing an instantaneous transmission power. For example, a PDₗᵢₘᵢₜ may be calculated as an integral of an instantaneous PD (PD (t)) over a time period, e.g.,

$$P {D}_{limit} = \frac{1}{T} {\int }_{0}^{T} PD ( t ) dt$$

426. Diagram 420 further illustrates that during a first time period (t₀-t₁) 422 of increased power density a coverage and/or a throughput may be improved, while during a second time period (t₁-t₂) 424 a power may be significantly decreased or reduced to zero to remain within the PD exposure limits. In some aspects, the decrease in the transmission power may lead to a communication to be dropped at time t₁ and during the time period (t₁-t₂) 424.

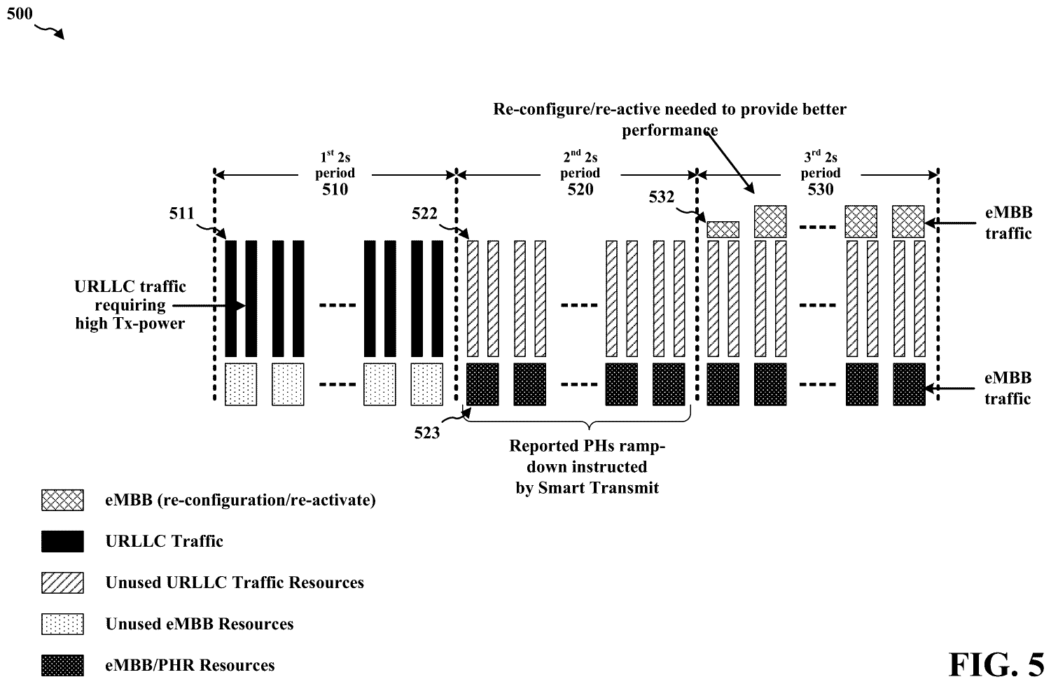

FIG. 5 is a diagram 500 illustrating a set of data and control transmissions associated with dynamic power control associated with RF exposure limits. A UE, during a first time period 510, may consume a large amount of Tx-power (e.g., full power transmission) to transmit URLLC traffic 511, with resources from a first CG-PUSCH, during the first, two-second period 510. For example, referring to FIG. 4, diagram 420 illustrates that during a first time period (t₀-t₁) 422, a UE may consume a larger amount of power (e.g., use a higher instantaneous transmission power). In a subsequent (e.g., second) two-second period 520, assuming there is no more, or less, URLLC traffic (e.g., indicated by unused URLLC resources 522, the UE may report, via eMMB/PHR resources 523. The UE may report a lower power headroom (PH) (together with a lower nominal UE max transit power (P_{cmax,f,c})) in one or more PH reports (PHRs) following the first period 510. For example, in the second period 520, the UE may report a reduced PH based on the higher transmission power used during the first period 510.

Based on the reported lower PH, a base station may activate one more CG-PUSCH for the UE starting from a third period 530, e.g., which may be two-seconds similar to the first and second periods. The scheduling may be too conservative (e.g., may indicate one of a lower MCS, a smaller number of RBs, a larger number of repetitions, a greater number of REs for CSI multiplexed on PUSCH) and the UE's performance may degrade based on the underestimation in the previously reported PH for this new CG-PUSCH. A UE may then begin to report a higher PH starting from the third period 530. The base station may determine that the scheduling of the new CG-PUSCH is too conservative and may transmit indications via eMMB resources 532 for re-configuration and/or re-activation of additional resources. The transmission of the additional re-configuration and/or re-activation indications introduces additional overhead. In some aspects, a UE may be instructed to frequently report PH, while a base station may also frequently re-configure and/or re-activate CG-PUSCH. These frequent PHRs and re-configuration and/or re-activation may be particularly problematic for CG-PUSCH.

A PHR, in some aspects, may include one or more types of information. For example, the PHR may include one or more of a difference between a nominal UE maximum transmit power and an estimated power for a UL-shared channel (e.g., PUSCH) transmission per activated serving cell (e.g., a Type-1 PH), a difference between a nominal UE maximum transmit power and an estimated power for a UL-shared channel (e.g., PUSCH) and PUCCH transmission on SPCell of the other MAC entity (e.g., an E-UTRA MAC entity in E-UTRA-NR Dual Connectivity (EN-DC), NR-E-UTRA Dual Connectivity (NE-DC), and NG-RAN-E-UTRA Dual Connectivity (NGEN-DC cases) (e.g., a Type-2 PH), a difference between a nominal UE maximum transmit power and an estimated power for SRS transmission per activated Serving Cell (e.g., a Type-3 PH), a power backoff to meet a specified maximum power event (MPE) for a Serving Cell operating on FR2 (e.g., an MPE power management maximum power reduction (P-MPR)). In some aspects, the PHR only addresses PH with respect to a single PUSCH/SRS/PUCCH transmission occasion, but does not address multiple PUSCH/SRS/PUCCH transmission occasions over a time window. For example, a Type-1 PH (e.g., a reported P_{cmax,f,c}(j)) is valid for a PUSCH transmission occasion i on an active UL BWP b of carrier f of serving cell c, where P_{cmax,f,c}(j) is the UE configured max output power for carrier f of serving cell c in PUSCH transmission occasion i. A PHR, in some aspects, may be triggered either periodically or event-based (e.g., MPE events, a path loss change that is greater than a threshold, etc.). In some aspects, a negative reported value in a PHR indicates that the reported value is a difference between a maximum transmission power and a calculated transmission power, while a positive reported value in a PHR indicates that the reported value is a difference between a maximum transmission power and a current transmission power. The nominal maximum transmit power P_{cmax,f,c}(j) may be reported in the PHR in addition to the reported PH in some aspects.

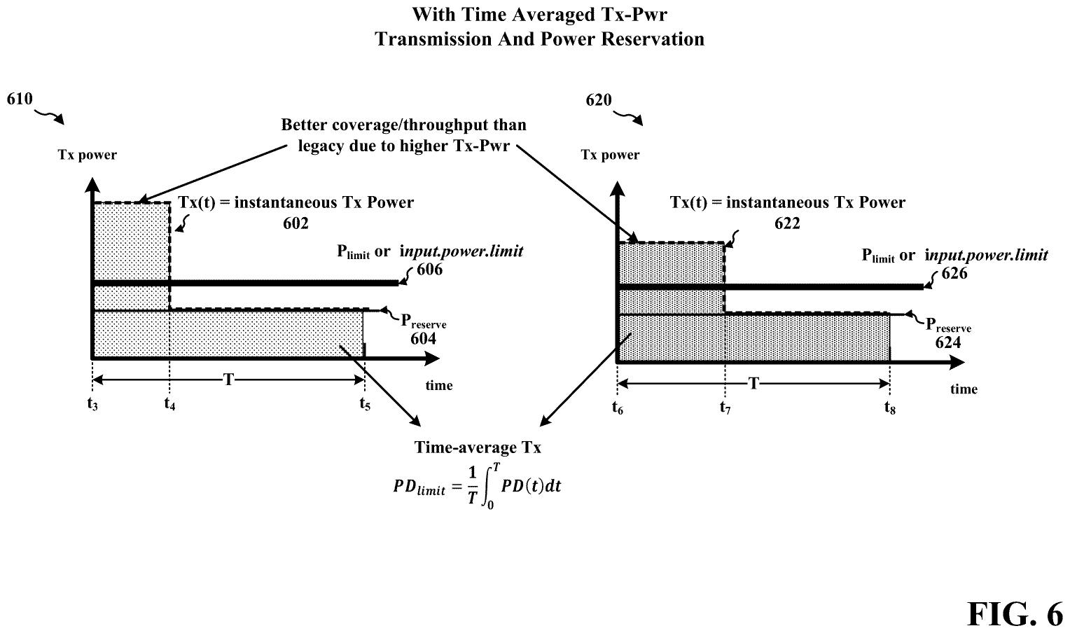

FIG. 6 is a set of diagrams 610 and 620 illustrating a dynamic power (e.g., transmission power) limit that takes advantage of time-averaging and a power reservation (e.g., a reserved power). Diagrams 610 and 620 illustrate that a wireless device may take advantage of time-averaging and a power reservation to improve coverage and/or throughput by increasing an instantaneous transmission power without suffering interrupted communication due to a significant decrease (or total reduction) in transmission power. For example, an instantaneous transmission power (e.g., Tx(t)) 602 or 622 may be increased to improve coverage and/or throughput during a first time period (t₃-t₄ or t₆-t₇). Contrary to the dynamic power limit illustrated in diagram 420 of FIG. 4, the first time period (t₃-t₄) of diagram 610 associated with an increased instantaneous transmission power 602 may be shorter than a first time period (t₀-t₁) 422 of diagram 420 of FIG. 4 in order to maintain a reserved power (Pᵣₑₛₑᵣᵥₑ) 604 throughout a second time period (t₄-t₅) instead of decreasing a transmission power or reducing a transmission power to zero, as shown in 420 in FIG. 4. Additionally, the first time period (t₆-t₇) of diagram 620 associated with an increased instantaneous transmission power 622 (e.g., an instantaneous transmission power that is lower than an instantaneous transmission power 602) may be the same or may be longer than the first time period (t₀-t₁) 422 of diagram 420 of FIG. 4 with a lower instantaneous power in order to maintain a reserved power (Pᵣₑₛₑᵣᵥₑ) 624 throughout a second time period (t₇-t₅) instead of dramatically decreasing a transmission power or reducing a transmission power to zero. In some aspects, maintaining a reserved power (Pᵣₑₛₑᵣᵥₑ) 604 or 624 may avoid dropping a call or other connection degradation. In both diagrams 610 and 620, a total power (e.g.,

$$\frac{1}{T} {\int }_{0}^{T} PD ( t ) dt )$$

may be the same to adhere to the PDₗᵢₘᵢₜ. The reserved power may be less than a power limit (Pₗᵢₘᵢₜ) 606 or 626.

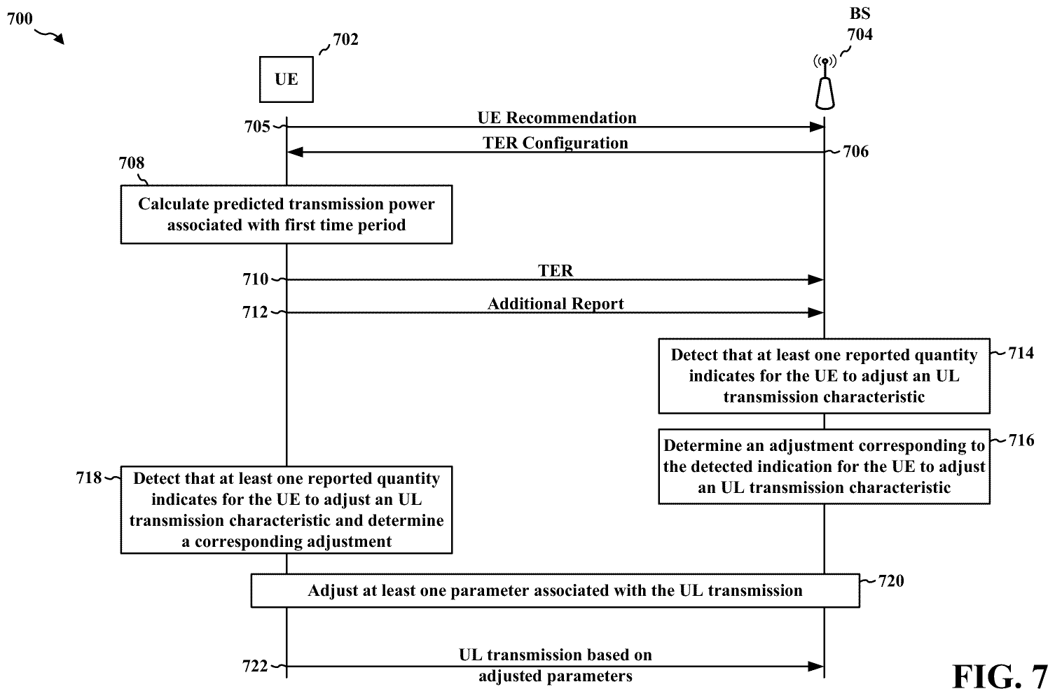

FIG. 7 is a call flow diagram 700 for a method of wireless communication. A base station 704 may transmit, and a UE 702 may receive, a transmit energy report (TER) configuration 706. The TER configuration 706, in some aspects, may include one of a first length of a first, previous time subperiod, a second length of a second, subsequent time subperiod, and a third length of time between the first, previous time subperiod and the second, subsequent time subperiod, where the third length of time may be one of a known length of time or a length of time received from the base station. In some aspects, the TER configuration 706 further includes an indication of at least one reference time, the at least one reference time including at least one of a beginning of the first, previous time subperiod, an end of the first, previous time subperiod, a beginning of the second, subsequent time subperiod, or an end of the second, subsequent time subperiod. The at least one reference time may be indicated based on one of a symbol, slot, subframe, a frame, or a reference time source. As one example of a reference time source, the reference time for the time window may be based on GNSS or other reference time source. The configuration of the first time period, in some aspects, may alternatively be one of known by the UE 702 or determined by the UE 702. In some aspects, the TER configuration may be received by the UE 702 from a base station via one of an RRC transmission, a MAC-CE, or a UCI transmission. The UE 702 may receive, from the base station 704, the TER configuration 706 may be a periodic or semi-persistent configuration or a dynamic indication (e.g., via DCI). In some aspects, the UE 702 may receive the TER configuration 706 from an upper layer, e.g., an application layer. As the TER is for a longer duration of time, the TER may be configured and/or reported via the upper layer. In some aspects, the base station may signal to the UE how to determine the time window(s) for a TER, e.g., signaling a starting point and/or ending point of a past time window, a starting point of a future time window, and/or a time window that includes prior time and future time. In some aspects, the base station may indicate a window length to the UE. In some aspects, the UE may transmit to the base station, at 705, a recommendation for the starting point, ending point, and/or length of a time window for the TER. The base station may base one of more parameter of the TER configuration 706 on the recommendation from the UE. In some aspects, the UE may determine the time window without signaling from the base station. As an example, the UE may use a duration of window length that is defined or otherwise known to the UE. As an example, in some aspects, the UE may autonomously determine one or more parameter of a time window, e.g., without one or more parameters of the time window being signaled to the UE. In some aspects, the UE may determine one or more of the ending point of a past time window, a starting point of a future time window, a starting point of a time window comprising both the past and the future time window for the TER report based on a PUSCH that carries the TER, e.g., based on a starting symbol, ending symbol, starting slot, ending slot, starting subframe, ending subframe of the PUSCH that will carry the TER.

A UE 702 may calculate 708 a predicted transmission power associated with one or more future transmissions within a first time period. In some aspects, the UE may determine whether an energy or average power corresponds to a past portion of the TER or a future portion of the TER. As an example, when the UE transmits a PUSCH carrying the TER, the energy used to transmit the PUSCH can be considered part of the future transmission energy or the past transmission energy. The UE may determine whether to include the transmission power of the PUSCH carrying the TER in the future transmission energy calculation or the past transmission energy calculation based on signaling from the base station, e.g., in the TER configuration; based on a recommendation that the UE provided to the base station; or based on a rule known to the UE. If the UE will transmit a single TER in multiple PUSCH transmission occasions (either a repetition of the single TER or transmitting sub-sets of the single TER in each of the PUSCH transmission occasions), the UE may calculate the energy consumed for all of the PUSCH transmission occasions or for a subset of the multiple PUSCH transmission occasions to be included with the future transmission energy or the past energy. The UE may determine whether to include the transmission power of one or more of the multiple PUSCH transmission occasions carrying the single TER in the future transmission energy calculation or the past transmission energy calculation based on signaling from the base station, e.g., in the TER configuration; based on a recommendation that the UE provided to the base station; or based on a rule known to the UE. In some aspects, the UE may include the transmission energy used before the PUSCH carrying the TER in a calculation of the past transmission energy. In some aspects, the UE may include the transmission energy used after the PUSCH carrying the TER in a calculation of the future transmission energy.

Calculating the predicted transmission power, in some aspects, includes calculating the predicted transmission power based on a duty cycle of uplink transmissions. The first time period, in some aspects, includes a first, previous time subperiod associated with a measured transmission power of a set of zero or more transmissions during the first, previous time subperiod and a second, subsequent time subperiod that is associated with the one or more future transmissions, and the TER relates to the measured transmission power and the predicted transmission power. The first, previous time subperiod may be a first length, the second, subsequent time subperiod may be of a second length and the first time period may include a third length of time between the first, previous time subperiod and the second, subsequent time subperiod, where the first length of time, the second length of time, and the third length of time are one of a known length of time or a length of time received from the base station (e.g., via TER configuration 706).

The UE 702 may transmit, and base station 704 may receive, a TER 710. The UE may transmit the TER in RRC, a MAC-CE, UCI, an upper layer (e.g., application layer) report, etc. The UE may transmit the TER as a periodic report. The UE may transmit the TER as an aperiodic or dynamic report. The TER 710 may include at least one of a length of the first time period, a beginning of the first time period, or an end of the first time period. In some aspects, the window lengths or starting/ending points of the time window(s) may be configured by the base station, e.g., at 706, and the UE may report the TER at 710 without reporting the window starting/ending point or length of the window on which the TER is based to the base station. In some aspects, the time windows may be configured to slide over time, and the base station may configure a sliding speed for the UE to use. In some aspects, the time windows may be sliding over time, where the UE determines the starting point of a future window or the ending point of a past window based on the starting symbol, starting slot, starting subframe, starting frame, ending symbol, ending slot, ending subframe, or ending frame of the PUSCH comprising the TER.

In some aspects, the UE may report at least one parameter of the window corresponding to the TER when transmitting the TER to the base station. As an example, the UE may indicate one or more of a window length(s) or starting/ending points to the base station. In some aspects, the remaining parameters, e.g., that are not reported by the UE may be previously configured by the base station or known to the UE and the base station. As an example, the window length may be configured by the base station, and the UE may report a starting and/or ending point of the window associated with the TER.

In some aspects, at least one of a window length, starting point, or ending point of the time window(s) may be defined or otherwise known to the UE and the base station, and the UE may transmit the TER without reporting the parameters of the time window. In some aspects, the length of the first time period may be indicated based on at least one of a number of microseconds, milliseconds, seconds, minutes, symbols, slots, subframes, or frames. In some aspects, a quantity reported in the TER may be a differential value, e.g., a delta or difference, relative to one or more of the previous TERs reported to the base station. As an example, the UE may report a first TER having a first value. The UE may later report a second TER reporting a difference relative to the first value of the first TER.

When reporting the TER, the UE may assume certain TDD UL duty cycle(s), which may be based on at least one of: a UE capability (such as maxUplinkDutyCycle-FR2), a rule or definition (e.g., a maximum percentage of symbols during Is that can be scheduled for uplink transmission at the UE maximum transmission power, so as to ensure compliance with applicable electromagnetic power density exposure requirements provided by regulatory bodies), a capability analogous to the maxUplinkDutyCycle-FR2, with the exception of other durations (e.g., 2s or 4s), another known TDD UL duty cycle, a TDD UL duty cycle signalled by the base station. In some aspects, the duty cycle to be used may be associated with another duty cycle that is known by the UE or that is indicated to the UE by the base station. For future time windows, the UE may assume that at least a portion of the TDD UL duty cycle(s) would comprise UL transmission. The amount of the TDD UL duty cycle(s) for the UE to consider comprising the UL transmission may be based on a rule or other information known to the UE or may be configured for the UE by the base station. For past time windows, the UE may calculate the TDD UL duty cycle(s) based on the actual signals transmitted by the UE.

The TER 710, in some aspects, may include one of an average transmission power over the first time period for at least one of a measured instantaneous transmission power (e.g., Tx(t)) or a predicted instantaneous transmission power (e.g., Tx_{pred}(t)). In some aspects, the TER 710 may include a maximum transmission power over the first time period for at least one of the measured instantaneous transmission power (e.g., Tx_{Actual}(t)) or the predicted instantaneous transmission power (e.g., Tx_{pred}(t)). The value reported in the TER 710 may be based on (1) a duration of the measured instantaneous transmission power multiplied by the duration of the transmission at that transmission power (e.g., ∫ₜ_{₀}_{-T}_{_{Past}}^{t}^{₀}Tx_{Actual}(t)dt, with Tₚₐₛₜ being the duration or length of the first, previous time subperiod, and t₀ being a current time or an end of the first, previous time subperiod) and/or (2) the predicted instantaneous transmission power (e.g., ∫ₜ_{₀}^{t}^{₀}^{+T}^{_{Future}}Tx_{pred}(t)dt, with t₀ being a current time or a beginning of the second, subsequent time subperiod, and T_{Future} being a duration or length of the second, subsequent time subperiod). As discussed above, the predicted transmission power (e.g., Tx_{Pred}(t)) may be based on a duty cycle for UL transmissions.

The average transmission power over the first time period for at least one of the measured instantaneous transmission power or the predicted instantaneous transmission power may be based on an integration of power over time (e.g.,

$$\frac{1}{{T}_{Future}} {\int }_{{t}_{0}}^{{t}_{0} + {T}_{F u t u r e}} T {x}_{P r e d} ( t ) dt ,$$

$$\frac{1}{{T}_{P a s t}} {\int }_{{t}_{0} - {T}_{P a s t}}^{{t}_{0}} T {x}_{Actual} ( t ) dt , \\ or \frac{1}{{T}_{F u t u r e + {T}_{P a s t}}} ( {\int }_{{t}_{0} - {T}_{P a s t}}^{{t}_{0}} T {x}_{Actual} ( t ) dt + {\int }_{{t}_{0}}^{{t}_{0} + {T}_{F u t u r e}} T {x}_{P r e d} ( t ) dt ) ) .$$

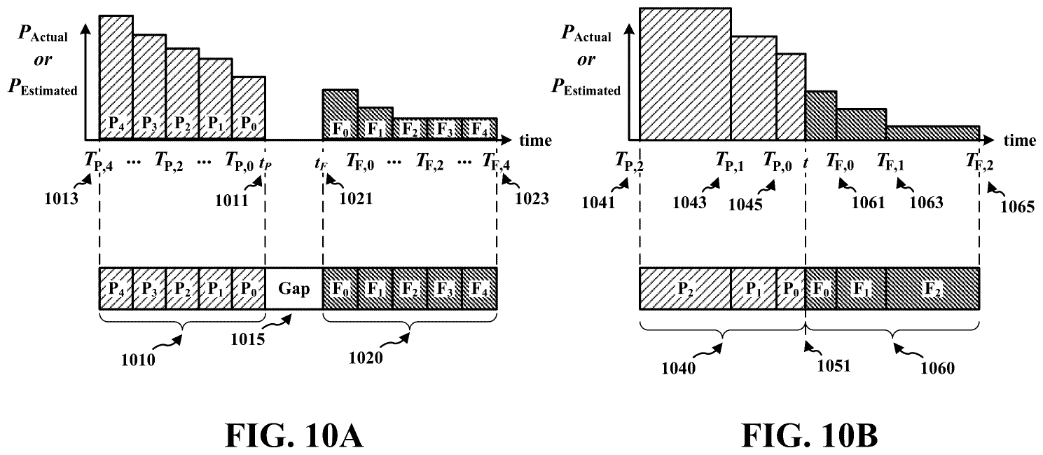

In some aspects, the first, previous time subperiod and the second, subsequent time subperiod may be of different durations (or lengths). In some aspects, e.g., as will be discussed below in relation to FIGS. 10A and 10B, a TER may include reported values (or quantities) for multiple past windows and future windows where each window may be of a same length or may be of different lengths. The TER 710 may be transmitted by the UE 702 via one of an RRC transmission, a MAC-CE, a UCI, or an application layer report. In some aspects, the UE may report a P-MPR level together with the TER. In some aspects, the UE may report a P-MPR level in a separate report that is associated with the TER. In some aspects, a reported P-MPR level may correspond to a minimum P-MPR value over a period of time, a maximum P-MPR value over a period of time, or an average P-MPR value of the period of time. The period of time may be a past time window, a future time window, or time window spanning past and future time. The time window for the P-MPR may be the same as for the associated TER or may be different than the time window for the TER. The time window for the P-MPR may be configured by the base station, recommended by the UE, or known to the UE and the base station. In some aspects, the UE may report an MPE event together with the TER. In some aspects, the UE may report an MPE event in a separate report that is associated with the TER. The period of time associated with the MPE event may be a past time window, a future time window, or time window spanning past and future time. The period of time associated with the MPE event may be the same as for the associated TER or may be different than the time window for the TER. The time window associated with the MPE event may be configured by the base station, recommended by the UE, or known to the UE and the base station. The UE may report an MPE event and a P-MPR. The time window associated with the P-MPR level and the MPE event may be the same or may be different, which may be based on a configuration from the base station, a UE recommendation, a rule, or a UE report. The TER 710 may include at least one reported quantity, where the reported quantity may be one of a predicted (e.g., estimated) maximum instantaneous transmission energy or average transmission power for the first time period (e.g., including a future time period or including a past and future time period), a preserved transmission power level, a duration of an MPE event, a P-MPR value, an interval between the current TER and a reference (previous) TER, and/or the time duration associated with the reported value.

In some aspects, reporting a preserved transmission power level may be interpreted as a promised minimum value of P_{cmax,f,c}. The preserved transmission power level may be defined over a future time window (e.g., a first, subsequent time subperiod), which can be the same time window as the future time window of the associated TER, or a separate window based on a known configuration at the UE, a configuration received from a base station, or a UE recommendation. The preserved transmission power level may be based on at least one of a transmission energy for a future window, a transmission energy for a past window, an average transmission energy for a future window, or an average transmission energy for a past window. The preserved transmission power level may be based on at least one of the window lengths of the future window (e.g., T_{Future}), a past window (e.g., T_{Present}) or a past/future window (e.g., T_{Future}+Tₚₐₛₜ). For example, a reported preserved transmission power (Pₚᵣₑₛₑᵣᵥₑ) may be a function of the transmission energy for a future window (e.g., f(E_{FutureWindow})=αE_{FutureWindow}, where α is a value between 0 and 1) and the UE may report f(E). In some aspects, a reported preserved transmission power (Pₚᵣₑₛₑᵣᵥₑ) may be a function of the transmission energy for a future window, a past window, and a time period associated with each of the future window and the past window (e.g., f(E_{FutureWindow}, E_{PastWindow}>T_{Future}, T_{Past}) and the UE may report the output of the function.

In some aspects, the TER 710 transmitted by the UE 702 may follow (may be subsequent to) a previous TER (not shown) and may indicate any of the values discussed above using differential values referencing at least one previously transmitted TER associated with at least one previous time period. In some aspects, the TER 710 may be transmitted based on at least one of a configured periodicity or a known or configured triggering event, the known or configured triggering event being one of (1) being configured with a CG-PUSCH, (2) receiving one of a P-CSI report, an SPS CSI report, a P-SRS transmission, or an SPS SRS transmission, or (3) the UE 702 determining to adjust a P-MPR or maximum output power (P_{cmax,f,c}(j)) beyond a known or configured threshold. In some aspects, the TER may be included in a PHR MAC-CE transmission where PHR behaviors may apply to the TER (e.g., a prohibit timer). In some aspects, the TER may be a deduction-based TER for which a future energy budget for the next T seconds can be determined by subtracting the energy transmitted in the last X-T seconds, where both T and X may be configured by the base station, recommended by the UE, or known to the UE and the base station. The UE 702 may transmit, and the base station 704 may receive, an additional report 712. The additional report 712 may be a preserved transmission power report indicating a value for a maximum output power associated with at least one of the one or more future transmissions within the first time period, where the value for the maximum output power may be based on the predicted transmission power. In some aspects, the additional report 712 may relate to at least one of (1) a maximum permissible exposure (MPE) associated with at least one of the one or more future transmissions within the first time period or (2) at least one of a minimum P-MPR value, a maximum P-MPR value, or an average P-MPR value associated with at least one of the one or more future transmissions within the first time period.

In some aspects, the UE may alter transmission parameters for uplink traffic, such as periodic or semi-persistent (e.g., SPS) uplink traffic, in response to criteria being met regarding a reported energy or an average transmission power. The adjustment by the UE may help to reduce control overhead for the base station to reconfigure or activate a configuration, e.g., for periodic or SPS uplink traffic. For example, the periodic or SPS uplink traffic may include a CG-PUSCH, a P-CSI report, an SPS-CSI report, a P-SRS, an SPS-SRS, etc. In some aspects, the configuration of configuration parameters for periodic or semi-persistent (e.g., SPS) uplink traffic based on energy or average transmission power reports may include frequent intermediate reconfigurations or re-activation of configurations in order to adjust an initial configuration for the UE. As an example, a transmit algorithm may dynamically adjust a maximum transmission power to meet emission requirements for any given time window. The dynamic adjustment of the transmission power may also lead to varied values in contiguous energy or average transmission power reports. By adjusting the uplink transmission parameter(s) when one or more criteria are met, the UE may help to reduce control overhead for the base station to reconfigure or activate a configuration. The rule, or criteria, for adjusting the uplink transmission parameter(s) may be known by the UE and the base station, configured by the base station for the UE, or otherwise agreed or indicated between the UE and the base station.

The base station 704, based on the TER 710 and/or the additional report 712 received from the UE 702, may detect 714 that at least one reported quantity indicates for the UE to adjust a UL transmission characteristic (e.g., of a periodic UL transmission or a semi-persistent scheduling UL transmission). Detecting 714 that at least one reported quantity indicates for the UE to adjust a UL transmission characteristic may be based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, the reported quantity being related to a maximum permissible exposure event, or a report of the MPE event. In some aspects, detecting 714 that at least one reported quantity indicates for the UE to adjust a UL transmission characteristic may be based on a configuration of any of the first, second, third, or fourth threshold values that may be known to the UE 702 and the base station 704, configured at the UE 702 by a transmission from the base station 704, or determined by the base station 704. The reported quantity may be one of a predicted (e.g., estimated) maximum instantaneous transmission energy or average transmission power for the first time period (e.g., including a future time period and/or a past time period), a preserved transmission power level, a duration of an MPE event, a P-MPR value, an interval between the current TER and a reference (previous) TER, and/or the time duration associated with at least one of the above report quantities. First, second, third, and/or fourth threshold values may be defined for, and associated with, each of the reported values in some aspects. The defined threshold values for different reported quantities (or values) may be independent of each other and, in some aspects, may be different for a same reported quantity associated with different channels or traffic types. For example, different threshold values may be defined for P-SRS and CG-PUSCH for a same reported quantity. In some aspects, a relationship between a criterion and the associated parameter adjustment(s), e.g., together with the starting/ending-points for such adjustment, can be based on a configuration for the UE from the base station, a UE recommendation, or a rule or other information known to the UE and the base station.

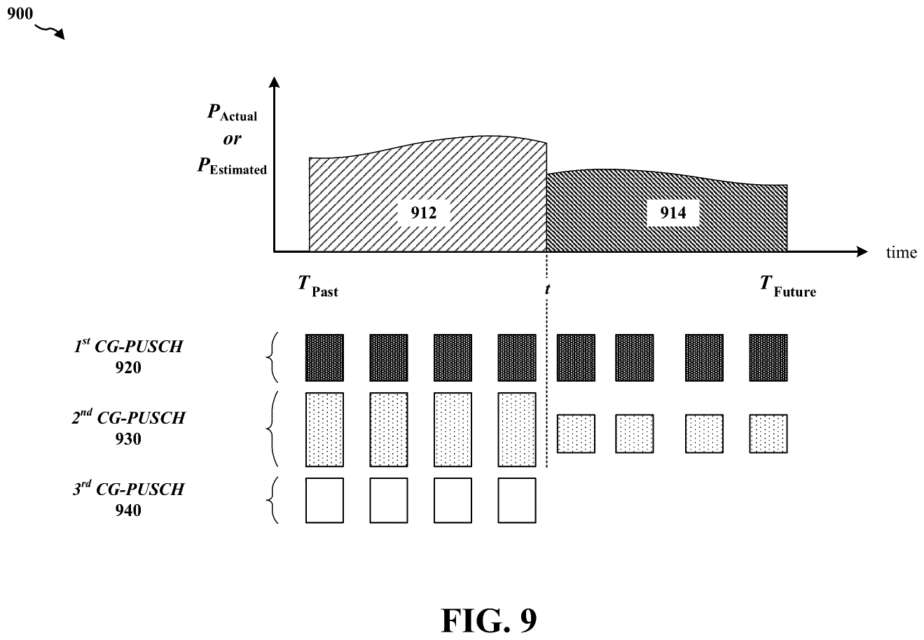

Detecting 714 that at least one reported quantity indicates for the UE to adjust a UL transmission characteristic (e.g., to adjust at least one parameter associated with the UL transmission) may determine 716 the corresponding adjustment. The determined 716 corresponding adjustment may be an adjustment to at least one of a bandwidth of a frequency domain resource allocation, a number of symbols in a time domain resource allocation, a modulation and coding scheme, a DMRS density, a number of repetitions, a periodicity of a CG, a transmission power, dropping transmissions associated with a CG-PUSCH, prioritizing resources associated with a CG-PUSCH, or an activation of resources associated with a CG-PUSCH. The determined 716 corresponding adjustment may further be based on a set of rules. The set of rules may include a set of priority rules relating to a plurality of CG-PUSCH resources, and a first magnitude of the adjustment to the at least one parameter may be based on at least one of an absolute value of the at least one reported quantity, a second magnitude of the increase of the at least one reported quantity, a third magnitude of the decrease of the at least one reported quantity, a difference between the at least one reported quantity and an associated threshold, or a priority of at least one of the plurality of CG-PUSCH resources. In some aspects, the first magnitude of the adjustment to the at least one parameter may be based on the content of a TER (e.g., whether the TER indicates an increase and/or decrease of the reported quantities that is beyond a threshold increase and/or decrease, a reported quantity and/or quantities that are either lower or higher than a threshold, or a report of an MPE), absolute values of the reported quantities, an increase and/or decrease amount of adjacent reported quantities, a difference between the reported quantities and the thresholds, or priorities of the CG-PUSCHs. The above criterion may be known to the UE and base station, configured by the base station, or reported and/or recommended by the UE. In some aspects, the determined 716 corresponding adjustment may be an adjustment to at least one additional parameter associated with one of a transmission of P-CSI, a transmission of a P-SRS, or a semi-persistent scheduling (SPS)-SRS. The at least one parameter for a P-CSI may include an increase or decrease in at least one of a reporting periodicity, a modulation coding scheme, or a beta-offset for CSI, while the at least one parameter for a P-SRS or SPS-SRS may include at least one of a bandwidth of a frequency domain resource allocation (FDRA), a number of symbols in a time domain resource allocation (TDRA), a modulation and coding scheme (MCS), a DM-RS density, a number of repetitions, a periodicity for a CG, dropping or activating a CG-PUSCH, a time-domain periodicity of the SRS, a frequency-hopping offset, a density of the SRS in a frequency domain, a transmission power (e.g., which may be associated with an increase/decrease of MCS/FDRA), or an activation of resources associated with a P-SRS configuration. FIG. 9 illustrates an example of a UE adjusting a parameter.

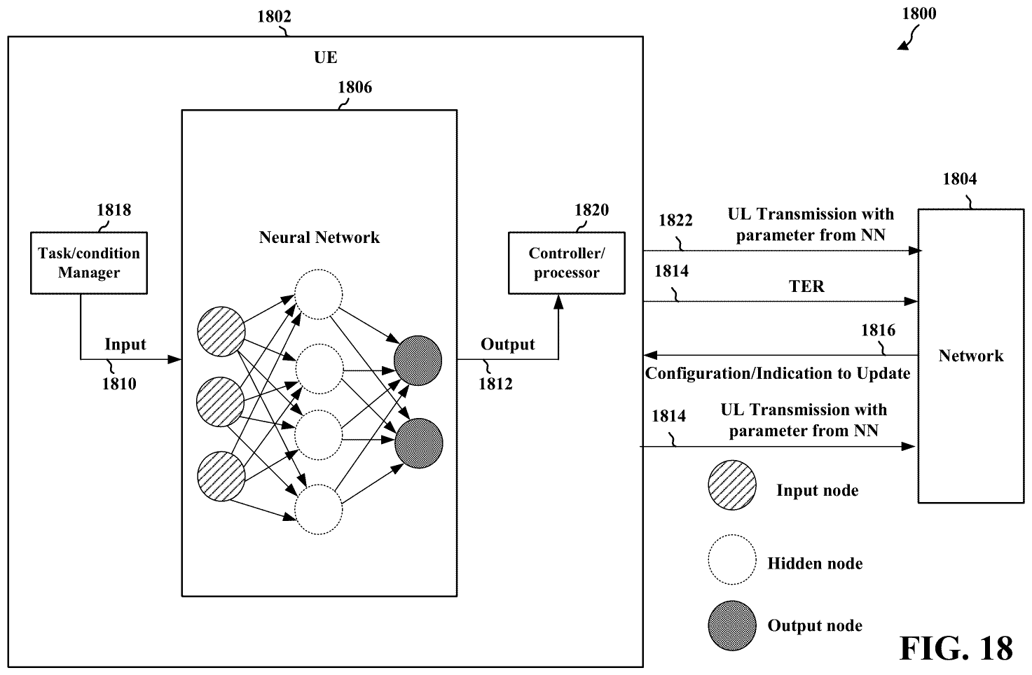

The determined 716 corresponding adjustment, in some aspects, may be based on a transmission (e.g., TER configuration 706) from base station 704 and received by UE 702 via one of at least one of a MAC-CE or a DCI that indicates one configuration of a plurality of configurations previously received via an RRC transmission from the base station 704. In some aspects, the UE may determine one or more uplink transmission parameters such as a transmission power based on machine learning, a neural network, or artificial intelligence. In some aspects, the base station may indicate an adjustment to a neuron in a neural network or machine learning component, such as a structure or coefficient, that the UE uses to determine a transmission power for uplink transmissions. The neural network, or machine learning component, may construct an algorithm for determining the transmission power, or other uplink transmission parameter, based on the indication from the base station. The construction of the algorithm may be further based on a previous configuration from the network. FIG. 18 illustrates an example of a UE including a neural network for a machine learning algorithm to determine one or more uplink transmission parameter.

The UE 702, in some aspects, may detect 718 that at least one reported quantity indicates for the UE to adjust a UL transmission characteristic (e.g., of a periodic UL transmission or a semi-persistent scheduling UL transmission) and determine a corresponding adjustment to the UL transmission characteristic. In some aspects, the UE 702 may detect 718 that at least one reported quantity indicates for the UE to adjust a UL transmission characteristic based on the content of the TER as described above in relation to detecting 714 that at least one reported quantity indicates for the UE to adjust a UL transmission characteristic. For example, the detecting 718 may be based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to a maximum permissible exposure event. In some aspects, detecting 714 that at least one reported quantity indicates for the UE to adjust a UL transmission characteristic may be based on a configuration of any of the first, second, third, or fourth threshold values that may be known to the UE 702 and the base station 704, configured at the UE 702 by a transmission from the base station 704, or determined by the base station 704.

Based on detecting 714 and 718 that at least one reported quantity indicates for the UE to adjust a UL transmission characteristic, the UE 702 and the base station 704 may adjust 720 at least one parameter associated with the UL transmission. The at least one parameter may include at least one of a bandwidth of a frequency domain resource allocation, a number of symbols in a time domain resource allocation, a modulation and coding scheme, a DMRS density, a number of repetitions, a periodicity of a CG, a transmission power, dropping transmissions associated with a CG-PUSCH, prioritizing resources associated with a CG-PUSCH, or an activation of resources associated with a CG-PUSCH. The adjustment 720 may further be based on a set of rules. The set of rules may include a set of priority rules relating to a plurality of CG-PUSCH resources, and a first magnitude of the adjustment to the at least one parameter may be based on at least one of an absolute value of the at least one reported quantity, a second magnitude of the increase of the at least one reported quantity, a third magnitude of the decrease of the at least one reported quantity, a difference between the at least one reported quantity and an associated threshold, or a priority of at least one of the plurality of CG-PUSCH resources. The set of rules may be known to both the UE 702 and the base station 704 (e.g., based on a pre-configuration and/or standard or based on a transmission from the base station 704 to UE 702 or vice versa).

In some aspects, the adjustment 720 may also adjust at least one additional parameter associated with one of a transmission of P-CSI, a transmission of a P-SRS, or a SPS-SRS. The at least one parameter for a P-CSI may include at least one of a reporting periodicity, a modulation coding scheme, or a beta-offset for CSI. Adjusting the beta-offset, in some aspects, may lead to omitting or including (e.g., de-omitting) certain quantities of the CSI based on priority rules associated with the quantities, e.g., dropping or de-dropping certain CSI-report(s), based on their priorities. In some aspects, different beta-offset increase and/or decrease rates may apply to CSI-Part1 and CSI-Part2, and to different CSI-reports. For example, a UE configured with a P-CSI report on a CG-PUSCH may detect an MPR event and report the MPE event to a base station suggesting decrease its average maximum transmission power by 3 dB for the next 1s (which may be confirmed by the base station) and the UE may determine to omit CSI-Part-2 and/or increase Beta-offset by 2, after receiving the base station confirmation of the TER and/or MPE event report. The at least one parameter for a P-SRS or SPS-SRS may include at least one of a bandwidth of a frequency domain resource allocation, a number of repetitions, a time-domain periodicity of the SRS, a frequency-hopping offset, a density of the SRS in a frequency domain (e.g., a comb density of the SRS), a transmission power, or an activation of resources associated with a P-SRS configuration (e.g., dropping and/or de-dropping, based on priority rules, of a certain P-SRS configuration, resource, or resource-set).

In some aspects, the adjustment 720 may occur at one of a first configured time after an ACK (not shown) is received, from the base station 704, at the UE 702 regarding the at least one reported quantity or a second configured time after a transmission time of a report including the at least one reported quantity. The configured time after the ACK or the configured time after the transmission time of the report including the at least one reported quantity may be indicated based on at least one of microseconds, milliseconds, seconds, minutes, symbols, slots, subframes, or frames. After adjusting 720 the at least one parameter associated with the UL transmission, the UE 702 may transmit, and base station 704 may receive, a UL transmission 722 (e.g., a periodic UL transmission or a semi-persistent scheduling UL transmission) based on the adjusted at least one parameter.

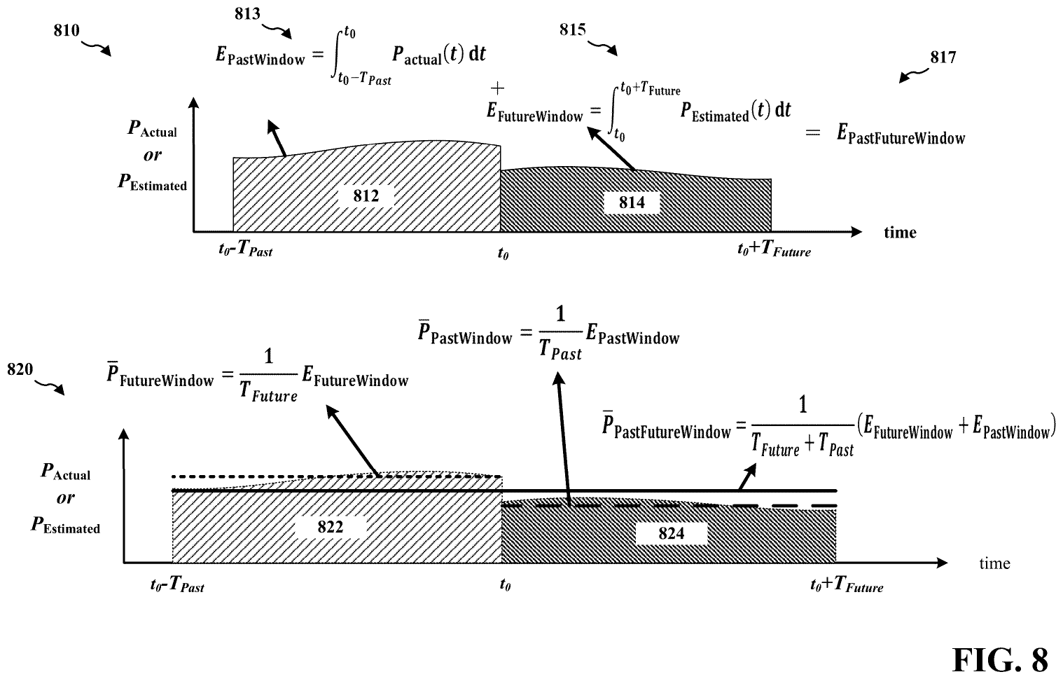

FIG. 8 illustrates a first and second method of calculating a reported value. Diagram 810 illustrates a method for calculating a reported transmit energy. For example, a transmit energy for a future time period 814 (e.g., a first, subsequent time subperiod in a first time period) may be calculated as E_{FutureWindow}=∫ₜ_{₀}^{t}^{₀}^{+T}^{_{Future}}P_{Estimated}(t)dt 815, where t₀ is a current time, T_{Future} is a duration of the future time period (window), and P_{Estimated}(t) is an estimated instantaneous transmission power. A transmit energy for a past time period 812 may be calculated as E_{PastWindow}=∫ₜ_{₀}_{-T}_{_{Past}}^{t}^{₀}P_{actual} (t)dt 813, where to is a current time, T_{Past} is a duration of the past time period (window), and P_{actual}(t) is a measured instantaneous transmission power. The TER, in some aspects, may relate to the measured transmission power and the predicted transmission power by including a measured transmission energy and/or a predicted transmission energy, where the measured transmission energy (e.g., E_{PastWindow} 813) may be based on a duration of a first, previous time subperiod (e.g., Tₚₐₛₜ) and the measured transmission power (e.g., P_{actual} (t)) and the predicted transmission energy (e.g., E_{FutureWindow} 815) is based on a duration of the second, subsequent time subperiod (e.g., T_{Future}) and the predicted transmission power (e.g., P_{Estimated} (t)). For example, the TER may include a report of E_{FutureWindow} 815 a report of E_{PastWindow} 813, or a report of E_{PastFutureWindow} 817, where E_{PastFutureWindow}=E_{FutureWindow}+E_{PastWindow}.

The future window may be determined based on a definition or configuration known to the UE, received from a base station, or a UE recommendation. If multiple PUSCH transmission occasions would carry a single TER (either repetition of the TER or each PUSCH carries a certain sub-set of a single TER), energy consumed for the multiple repetitions or portions of TER transmitted via the multiple PUSCH transmission occasions may be calculated as part of the future window or the past window. In some aspects, the energy to be consumed after the PUSCH carrying the TER may be associated with the future window, while the energy consumed before the PUSCH carrying the TER may be associated with the past window considered as in the past.

Diagram 820 illustrates a method for calculating a reported average transmission power. For example, an average transmission energy for a future window 824 (e.g., a first, subsequent time subperiod in a first time period) may be calculated as

$${\overline{P}}_{F u t u r e W i n d o w} = \frac{1}{{T}_{F u t u r e}} {E}_{FutureWindow} = \frac{1}{{T}_{F u t u r e}} {\int }_{{t}_{0}}^{{t}_{0} + {T}_{F u t u r e}} {P}_{Estimated} ( t ) dt ,$$

where t₀ is a current time, T_{Future} is a duration of the future window, and P_{Estimated}(t) is an estimated instantaneous transmission power. An average transmission energy for a past window 822 may be calculated as

$${\overline{P}}_{PastWindow} = \frac{1}{{T}_{Past}} {E}_{PastWindow} = \frac{1}{{T}_{Past}} {\int }_{{t}_{0} - {T}_{Past}}^{{t}_{0}} {P}_{actual} ( t ) dt ,$$

where t₀ is a current time, T_{Past} is a duration of the past window, and P_{actual}(t) is a measured instantaneous transmission power. The TER may include a report of P̅_{FutureWindow} or a report of

$$\frac{1}{{T}_{F uture} + {T}_{Past}} ( {E}_{F u t u r e W i n d o w} + {E}_{P a s t W i n d o w} ) = \frac{1}{{T}_{F uture} + {T}_{Past}} ( {\int }_{{t}_{0}}^{{t}_{0} + {T}_{F u t u r e}} {p}_{E s t i m ated} ( t ) dt + {\int }_{{t}_{0} - {T}_{P a s t}}^{{t}_{0}} {p}_{actual} ( t ) dt ) .$$

FIG. 9 is a diagram 900 illustrating an example of dropping a low-priority transmission based on a TER. A UE may be configured with 3 CG-PUSCH resources 920, 930, and 940 with different priorities. For example, a first CG-PUSCH 920 may have a highest priority, a second CG-PUSCH 930 may have a lower priority, and a third CG-PUSCH 940 may have a lowest priority. The UE may detect an MPE event and transmit a TER to a base station based on the energy associated with the actual (past) power (P_{actual}) 912 and an estimated (future) power (P_{Estimated}) 914. The transmitted TER may indicate for the UE (and the base station) to decrease an average maximum transmission power (e.g., by 6 dB) for a next time period (e.g., one second).

The magnitude of the adjustment and the duration of the adjustment may be determined based on the magnitude of a reported quantity and a set of rules as discussed in relation to FIG. 7. The adjustment may be made by the UE autonomously based on the reported quantity and the set of rules or may be made in response to an indication transmitted by a base station based on the TER. To implement the adjustment, the UE may drop transmissions associated with the third CG-PUSCH 940 and reduce a set of resources (e.g., frequency domain resources and/or time domain resources) for transmissions associated with the second CG-PUSCH 930 while maintaining the configuration for the highest priority transmissions (or resources) of the first CG-PUSCH 920.

FIG. 10A is a diagram illustrating a set of multiple time periods of equal durations or lengths for reporting in a TER. FIG. 10A also illustrates that, in some aspects, a gap 1015 may be introduced between a set of past time windows P₀-P₄ 1010 and a set of future time windows F₀-F₄ 1020. The TER may include an indication of a time (tₚ) 1011 that marks the end of a set of past windows, an indication of a time (T_{p,4}) 1013 that marks the beginning of the set of past windows, and an indication of a number of equal-length past time widows. In some aspects, the TER may indicate a beginning (or end) time for each past time window in the set of past time windows 1010 and an end time (tₚ) 1011 for a last (e.g., a most recent) past time window (P₀) in the set of past time windows 1010.

Similarly, the TER may include an indication of a time (tₚ) 1021 that marks the beginning of the set of future time windows 1020, an indication of a time (T_{F,4}) 1023 that marks the end of the set of future time windows 1020, and an indication of a number of equal-length future time widows F₀-F₄ that may be of the same or different lengths from the past time windows P₀-P₄ and may be a same or different number of time windows. In some aspects, the TER may indicate an end (or beginning) time for each future time window in the set of future time windows 1020 and a beginning time (t_{F}) 1021 for a first future time window (F₀) in the set of future time windows 1020. The TER, in some aspects, may indicate a beginning of the set of past time windows (e.g., time (T_{p,4}) 1013) and a duration of each of the set of past time windows 1010, the gap 1015, and the set of future time windows 1020. In some aspects, the set of past time windows 1010 and the set of future time windows 1020 may be identified based on a known configuration (based on a pre-configuration or a received RRC message) and a resource used to transmit the TER. For example, the set of past time windows 1010 and the set of future time windows 1020 may be determined based on an offset from a symbol in which the TER is transmitted.

FIG. 10B is a diagram illustrating a set of multiple time periods of unequal durations or lengths for reporting in a TER. The TER may include an indication of a current time (t) 1051 that marks the end of a set of past time windows 1040, a set of indications of a set of times (e.g., T_{p,2}, T_{p,1}, T_{p,0}) 1041, 1043, and 1045 that mark the beginning of the past windows in the set of past time windows 1040, and a set of indications of set of times (e.g., T_{F,0}, T_{F,1}, T_{F,2}) 1061, 1063, and 1065 that mark the end of the future windows in the set of future time windows 1060. Each time window may be of different lengths with time periods closer to a current time being shorter than time periods farther from a current time or vice versa. In some aspects, the set of past time windows 1040 and the set of future time windows 1060 may be identified based on a known configuration (based on a pre-configuration or a received RRC message) and a resource (or a current time t) used to transmit the TER. For example, the set of past time windows 1040 and the set of future time windows 1060 may be determined based on an offset from a symbol in which the TER is transmitted.

FIG. 10A illustrates an example in which the sub-window lengths have a same length, and FIG. 10B illustrates an example in which the sub-window lengths may have different lengths.

FIG. 18 illustrates a diagram 1800 of a UE 1802 that includes a neural network 1806 configured to determine an uplink transmission parameter for a transmission to a base station 704. A UE may use machine-learning algorithms, deep-learning algorithms, neural networks, reinforcement learning, regression, boosting, or advanced signal processing methods for aspects of wireless communication, e.g., with a base station, a TRP, another UE, etc.

Reinforcement learning is a type of machine learning that involves the concept of taking actions in an environment in order to maximize a reward. Reinforcement learning is a machine learning paradigm; other paradigms include supervised learning and unsupervised learning. Basic reinforcement may be modeled as a Markov decision process (MDP) having a set of environment and agent states, and a set of actions of the agent. The process may include a probability of a state transition based on an action and a representation of a reward after the transition. The agent's action selection may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples. Federated learning (FL) procedures that use edge devices as clients may rely on the clients being trained based on supervised learning.

Regression analysis may include statistical processes for estimating the relationships between a dependent variable (e.g., which may be referred to as an outcome variable) and independent variable(s). Linear regression is one example of regression analysis. Non-linear models may also be used. Regression analysis may include inferring causal relationships between variables in a dataset.

Boosting includes one or more algorithms for reducing bias and/or variance in supervised learning, such as machine learning algorithms that convert weak learners (e.g., a classifier that is slightly correlated with a true classification) to strong ones (e.g., a classifier that is more closely correlated with the true classification). Boosting may include iterative learning based on weak classifiers with respect to a distribution that is added to a strong classifier. The weak learners may be weighted related to accuracy. The data weights may be readjusted through the process. In some aspects described herein, an encoding device (e.g., a UE, base station, or other network component) may train one or more neural networks to learn dependence of measured qualities on individual parameters.

Among others, examples of machine learning models or neural networks that may be included in the UE 1802 include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with an input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. FIG. 18 illustrates that an example neural network 1806 may include a network of interconnected nodes. An output of one node is connected as the input to another node. Connections between nodes may be referred to as edges, and weights may be applied to the connections/edges to adjust the output from one node that is applied as the input to another node. Nodes may apply thresholds in order to determine whether, or when, to provide output to a connected node. The output of each node may be calculated as a non-linear function of a sum of the inputs to the node. The neural network 1806 may include any number of nodes and any type of connections between nodes. The neural network 1806 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times. As an example, the UE 1802 may input information 1810 to the neural network 1806 (e.g., via a task/condition manager 1818), and may receive output 1812 (e.g., via a controller/processor 1820). The UE 1802 may report information 1814 (such as a TER described in connection with FIG. 7) to the base station 1804 based on the output 1812. As described herein, the base station may adjust a coefficient, weight, etc. for a neuron or other aspect of a neural network or machine learning component of the UE 1802 and may transmit a configuration or indication 1816 to update the coefficient, weight, etc. The UE 1802 may apply the adjustment and construct an adjusted algorithm that the UE uses to determine one or more uplink transmission parameters, such as a transmission power. The UE may then transmit an uplink transmission 1822 using an uplink transmission parameter determined by the neural network. In some aspects, the UE may also apply an adjustment based on one or more criteria being met.

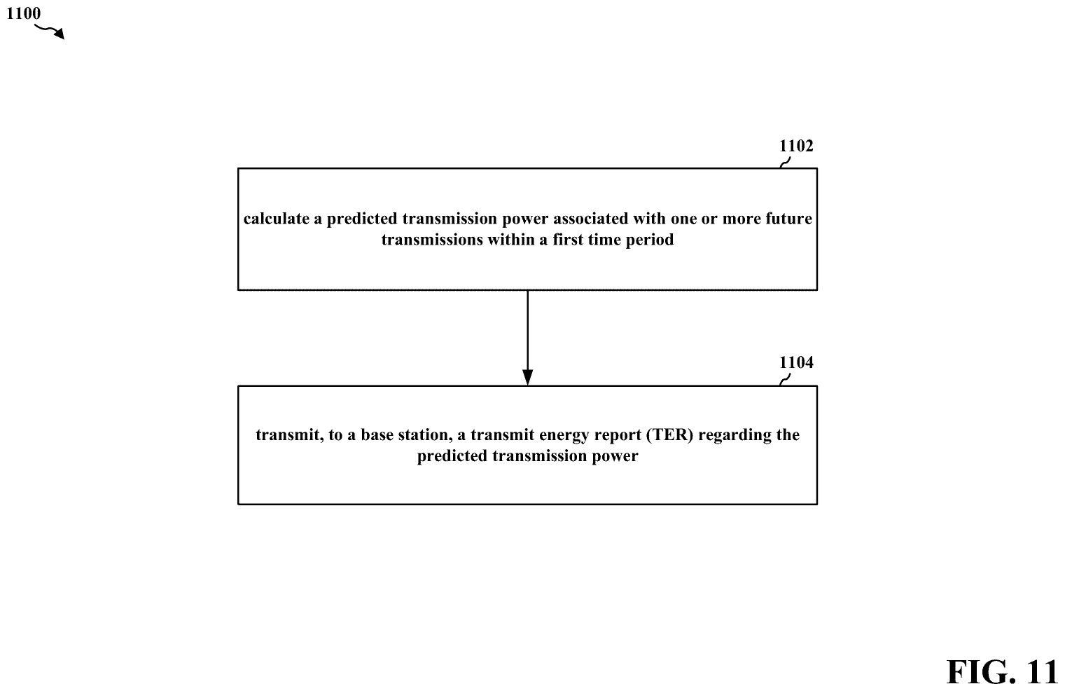

FIG. 11 is a flowchart 1100 of a method of wireless communication. The method may be performed by a UE (e.g., the UE 104 or 702; the apparatus 1602). At 1102, the UE may calculate a predicted transmission power associated with one or more future transmissions within a first time period. For example, 1102 may be performed by transmission power prediction component 1640. Calculating the predicted transmission power, in some aspects, includes calculating the predicted transmission power based on a duty cycle of uplink transmissions. In some aspects, the first time period includes a first, previous time subperiod associated with a measured transmission power of a set of zero or more transmissions during the first, previous time subperiod and a second, subsequent time subperiod that is associated with the one or more future transmissions, and the TER relates to the measured transmission power and the predicted transmission power. For example, referring to FIGS. 7, 8, 9, 10A, and 10B, a UE 702 may calculate 708 a predicted transmission power associated with a first time period that may include a past time window 812/822/912 and/or a future time window 814/824/914 or may include a set of past time windows 1010 or 1040 and/or a set of future time windows 1020 or 1060.

A configuration of the first time period, in some aspects, includes one of a first length of the first, previous time subperiod, a second length of the second, subsequent time subperiod, and a third length of time between the first, previous time subperiod and the second, subsequent time subperiod, where the first length of time, the second length of time, and the third length of time are one of a known (e.g., preconfigured) length of time or a length of time received from the base station. In some aspects, the configuration further includes an indication of at least one reference time, the at least one reference time including at least one of a beginning of the first, previous time subperiod, an end of the first, previous time subperiod, a beginning of the second, subsequent time subperiod, or an end of the second, subsequent time subperiod. The at least one reference time, in some aspects, may be indicated based on one of a symbol, slot, subframe, a frame, or a reference time. In some aspects, the configuration of the first time period may be one of known (e.g., preconfigured), configured by the base station, or determined by the UE. In some aspects, a configuration associated with the TER may be received from a base station via one of an RRC transmission, a MAC-CE, or a UCI. The configuration, in some aspects, may be received based on at least one of a configured periodicity or a dynamic indication from the base station.

At 1104, the UE may transmit, to a base station, a TER regarding the predicted transmission power. For example, 1104 may be performed by transmission energy reporting component 1642. In some aspects, the TER may be based on a duration of the measured transmission power multiplied by the measured transmission power and the predicted transmission power. The TER, in some aspects, relates to at least one of an average transmission power over the first time period or a maximum transmission power over the first time period for at least one of the measured transmission power or the predicted transmission power. In some aspects, the TER includes at least one of a length of the first time period, a beginning of the first time period, or an end of the first time period. The length of the first time period, in some aspects, may be indicated based on at least one of a number of microseconds, milliseconds, seconds, minutes, symbols, slots, subframes, or frames. In some aspects, the TER includes differential values referencing at least one previously transmitted TER associated with at least one previous time period. The TER regarding the predicted transmission power, in some aspects, includes a report for a set of two or more time subperiods. In some aspects, the set of two or more time subperiods include time subperiods of different lengths. For example, referring to FIGS. 7, 8, 10A, and 10B, the UE 702 may transmit a TER 710 to a base station 704 based on a predicted transmission power 815 and/or 817 related to a past time period 812 and/or future time period 814 or a predicted transmission power associated with the set of past time windows 1010 or 1040 and/or a set of future time windows 1020 or 1060.

In some aspects, the TER may be transmitted via one of an RRC transmission, a MAC-CE, a UCI, or an application layer report. In some aspects, the TER may be transmitted via a PHR MAC-CE. The TER, in some aspects, may be transmitted based on at least one of a configured periodicity or a configured triggering event, the configured triggering event being one of (1) receiving one of a CG-PUSCH transmission, a P-CSI report, a SPS CSI report, a P-SRS transmission, or an SPS SRS transmission or (2) the UE determining to adjust a maximum output power beyond a configured (or known) threshold.

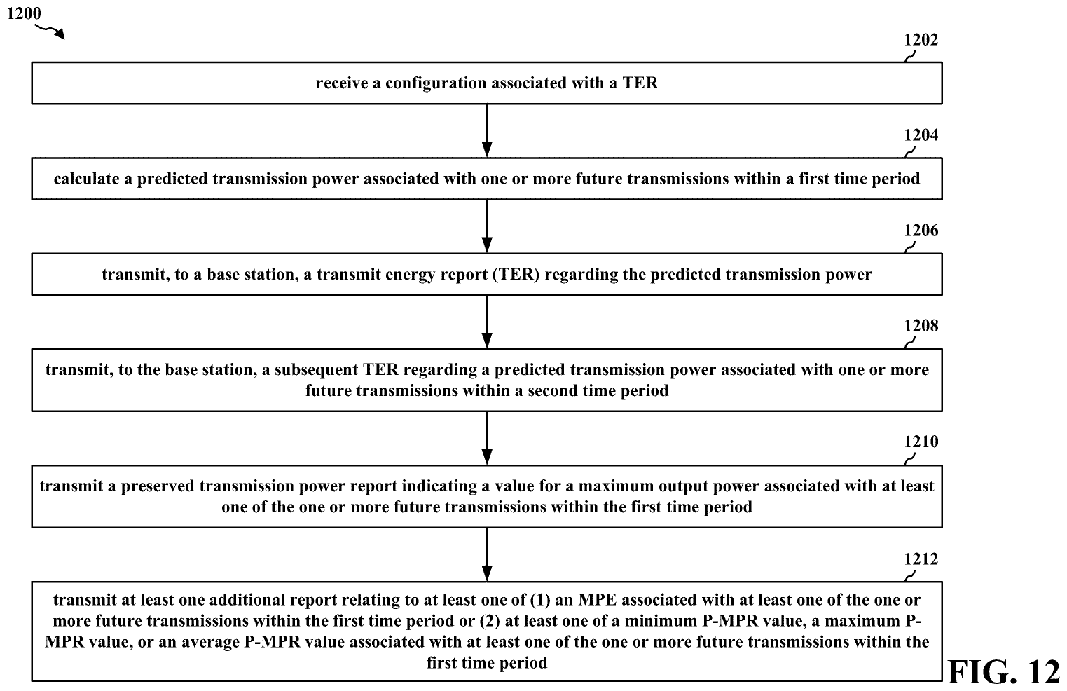

FIG. 12 is a flowchart 1200 of a method of wireless communication. The method may be performed by a UE (e.g., the UE 104 or 702; the apparatus 1602). At 1202, the UE may receive a configuration associated with a TER. For example, 1202 may be performed by transmission power prediction component 1640. The configuration associated with the TER may include a configuration of a first time period. The configuration of the first time period, in some aspects, includes one of a first length of a first, previous time subperiod, a second length of a second, subsequent time subperiod, and a third length of time between the first, previous time subperiod and the second, subsequent time subperiod, where the first length of time, the second length of time, and the third length of time are one of a known length of time or a length of time received from the base station. In some aspects, the configuration includes an indication of at least one reference time, the at least one reference time including at least one of a beginning of the first, previous time subperiod, an end of the first, previous time subperiod, a beginning of the second, subsequent time subperiod, or an end of the second, subsequent time subperiod. The at least one reference time, in some aspects, may be indicated based on one of a symbol, slot, subframe, a frame, or a reference time. In some aspects, the configuration of the first time period may be one of, known (e.g., preconfigured), configured by the base station, or determined by the UE. In some aspects, the configuration associated with the TER may be received from a base station via one of an RRC transmission, a MAC-CE, or a UCI. The configuration, in some aspects, may be received based on at least one of a configured periodicity or a dynamic indication from the base station. For example, referring to FIG. 7, the UE 702 may receive, from a base station 704, a TER configuration 706.

At 1204, the UE may calculate a predicted transmission power associated with one or more future transmissions within a first time period. For example, 1204 may be performed by transmission power prediction component 1640. Calculating the predicted transmission power, in some aspects, includes calculating the predicted transmission power based on a duty cycle of uplink transmissions. In some aspects, the first time period includes the first, previous time subperiod associated with a measured transmission power of a set of zero or more transmissions during the first, previous time subperiod and the second, subsequent time subperiod that is associated with the one or more future transmissions, and the TER relates to the measured transmission power and the predicted transmission power. For example, referring to FIGS. 7, 8, 9, 10A, and 10B, a UE 702 may calculate 708 a predicted transmission power associated with a first time period that may include a past time window 812/822/912 and/or a future time window 814/824/914 or may include a set of past time windows 1010 or 1040 and or a set of future time windows 1020 or 1060.

At 1206, the UE may transmit, to a base station, a TER regarding the predicted transmission power. For example, 1206 may be performed by transmission energy reporting component 1642. In some aspects, the TER may be based on a duration of the measured transmission power multiplied by the measured transmission power and the predicted transmission power. The TER, in some aspects, relates to at least one of an average transmission power over the first time period or a maximum transmission power over the first time period for at least one of the measured transmission power or the predicted transmission power. In some aspects, the TER includes at least one of a length of the first time period, a beginning of the first time period, or an end of the first time period. The length of the first time period, in some aspects, may be indicated based on at least one of a number of microseconds, milliseconds, seconds, minutes, symbols, slots, subframes, or frames. In some aspects, the TER includes differential values referencing at least one previously transmitted TER associated with at least one previous time period. The TER regarding the predicted transmission power, in some aspects, includes a report for a set of two or more time subperiods. In some aspects, the set of two or more time subperiods include time subperiods of different lengths. For example, referring to FIGS. 7, 8, 10A, and 10B, the UE 702 may transmit a TER 710 to a base station 704 based on a predicted transmission power 815 and/or 817 related to a past time period 812 and/or future time period 814 or a predicted transmission power associated with the set of past time windows 1010 or 1040 and/or a set of future time windows 1020 or 1060.

In some aspects, the TER may be transmitted via one of an RRC transmission, a MAC-CE, a UCI, or an application layer report. In some aspects, the TER may be transmitted via a PHR MAC-CE. The TER, in some aspects, may be transmitted based on at least one of a configured periodicity or a configured triggering event, the configured triggering event being one of (1) receiving one of a CG-PUSCH transmission, a P-CSI report, a SPS CSI report, a P-SRS transmission, or an SPS SRS transmission or (2) the UE determining to adjust a maximum output power beyond a configured threshold.

At 1208, the UE may transmit, and a base station may receive, a subsequent TER regarding an additional predicted transmission power associated with one or more additional future transmissions within a second time period. For example, 1208 may be performed by transmission energy reporting component 1642. The time between a beginning of the first time period and a beginning of the second time period may be based on at least one of a value known by the UE, a configuration received from the base station, or a beginning of a transmission including the subsequent TER associated with the second time period. For example, referring to FIGS. 7, 8, 10A, and 10B, the UE 702 may transmit a subsequent TER similar to TER 710 to a base station 704 based on a predicted transmission power 815 and/or 817 related to a past time period 812 and/or future time period 814 or a predicted transmission power associated with the set of past time windows 1010 or 1040 and/or a set of future time windows 1020 or 1060.

At 1210, the UE may transmit, and a base station may receive, a preserved transmission power report indicating a value for a maximum output power associated with at least one of the one or more future transmissions within the first time period. For example, 1210 may be performed by transmission energy reporting component 1642. The value for the maximum output power may be based on the predicted transmission power. For example, referring to FIGS. 6 and 7, the UE may transmit an additional report 712 regarding a reserved power (Pᵣₑₛₑᵣᵥₑ) 604 or 624.

Finally, at 1212, the UE may transmit, and a base station may receive, at least one additional report relating to at least one of (1) an MPE associated with at least one of the one or more future transmissions within the first time period or (2) at least one of a minimum P-MPR value, a maximum P-MPR value, or an average P-MPR value associated with at least one of the one or more future transmissions within the first time period. For example, 1212 may be performed by transmission energy reporting component 1642. For example, referring to FIG. 7, the UE 702 may transmit an additional report 712.

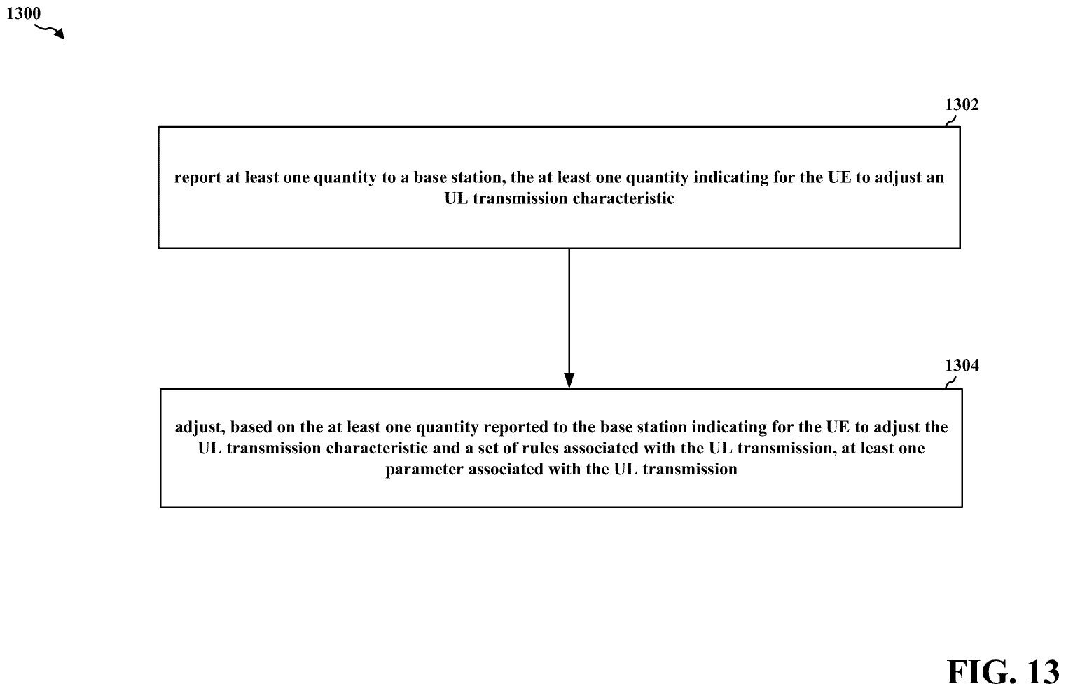

FIG. 13 is a flowchart 1300 of a method of wireless communication. The method may be performed by a UE (e.g., the UE 104 or 702; the apparatus 1602). At 1302, the UE may report at least one quantity to a base station, the at least one quantity indicating for the UE to adjust an UL transmission characteristic. The UL transmission, in some aspects, includes one of a periodic UL transmission or a semi-persistent scheduling UL transmission. For example, 1302 may be performed by transmission energy reporting component 1642. In some aspects, the at least one quantity may indicate for the UE to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to an MPE event. For example, referring to FIG. 7, the UE 702 may transmit (or report), and a base station 704 may receive, a TER 710 that includes at least one quantity that may indicate for the UE (e.g., based on detecting 714 or 718) to adjust the UL transmission characteristic.

At 1304, the UE may adjust, based on the at least one quantity reported to the base station indicating for the UE to adjust the UL transmission characteristic and a set of rules associated with the UL transmission, at least one parameter associated with the UL transmission. For example, 1304 may be performed by implicit adjustment component 1644. Adjusting the at least one parameter associated with the UL transmission, in some aspects, may be further based on a transmission from the base station. The transmission from the base station, in some aspects, may include at least one of a MAC-CE or a DCI that indicates one configuration of a plurality of configurations received via an RRC from the base station. For example, referring to FIG. 7, the UE 702 may adjust 720 at least one parameter associated with the UL transmission based on the at least one quantity reported to the base station, e.g., via TER 710, indicating for the UE to adjust the UL transmission characteristic.

In some aspects, adjusting the at least one parameter associated with the UL transmission occurs at one of a first configured time after an ACK is received at the UE regarding the at least one reported quantity or a second configured time after a transmission time of a report including the at least one reported quantity. The configured time after the ACK or the configured time after the transmission time of the report including the at least one reported quantity, in some aspects, may be indicated based on at least one of microseconds, milliseconds, seconds, minutes, symbols, slots, subframes, or frames. In some aspects, adjusting the at least one parameter includes adjusting at least one of a bandwidth of a frequency domain resource allocation, a number of symbols in a time domain resource allocation, a modulation and coding scheme, a DMRS density, a number of repetitions, a periodicity of a CG, a transmission power, dropping transmissions associated with a CG-PUSCH, prioritizing resources associated with a CG-PUSCH, or an activation of resources associated with a CG-PUSCH.

The set of rules associated with the UL transmission, in some aspects, includes a set of priority rules relating to a plurality of CG-PUSCH resources. A magnitude of the adjustment to the at least one parameter, in some aspects, may be based on a priority of at least one of the plurality of CG-PUSCH. In some aspects, a first magnitude of the adjustment to the at least one parameter may be based on at least one of an absolute value of the at least one reported quantity, a second magnitude of the increase of the at least one reported quantity, a third magnitude of the decrease of the at least one reported quantity, or a difference between the at least one reported quantity and an associated threshold. Adjusting the at least one parameter associated with the UL transmission, in some aspects, includes adjusting at least one parameter associated with transmission of a periodic CSI, where the at least one parameter includes at least one of a reporting periodicity, a modulation coding scheme, or a beta-offset for CSI. In some aspects, adjusting the at least one parameter associated with the UL transmission includes adjusting at least one parameter associated with transmission of at least one of a P-SRS or a SPS-SRS, and the at least one parameter includes at least one of a bandwidth of a frequency domain resource allocation, a number of repetitions, a time-domain periodicity of the SRS, a frequency-hopping offset, a density of the SRS in a frequency domain, a transmission power, or an activation of resources associated with a P-SRS configuration.

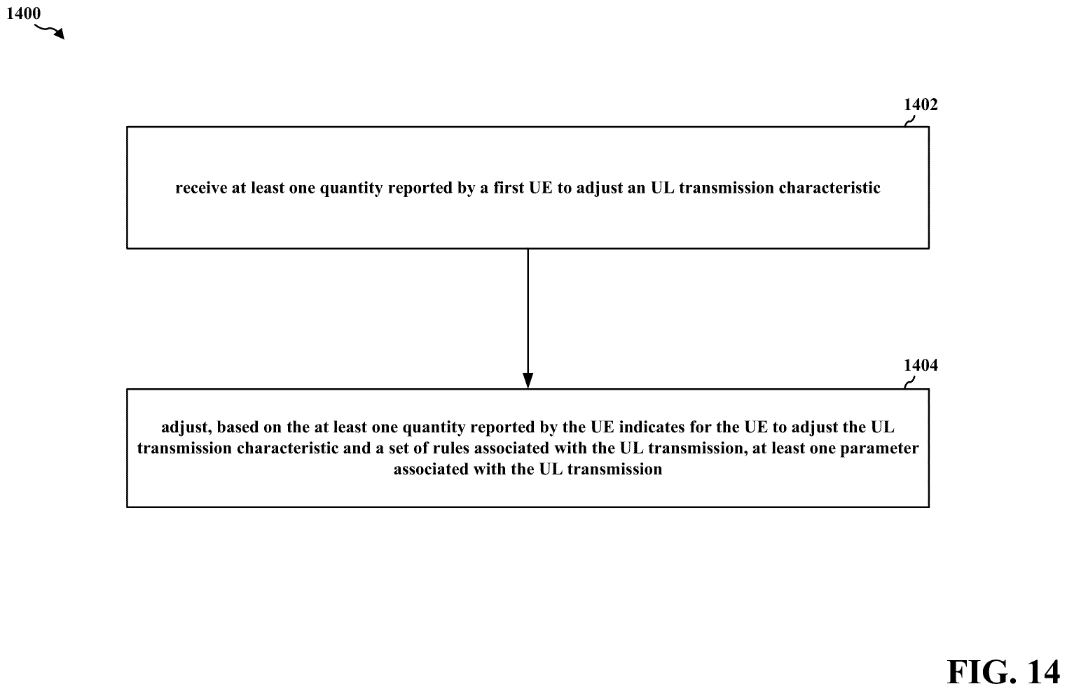

FIG. 14 is a flowchart 1400 of a method of wireless communication. The method may be performed by a base station (e.g., the base station 102/180 or 704; the apparatus 1702). At 1402, the base station may receive, from a UE, at least one quantity reported by a UE to adjust an UL transmission characteristic. The UL transmission, in some aspects, includes one of a periodic UL transmission or a semi-persistent scheduling UL transmission. For example, 1402 may be performed by implicit adjustment component 1742. In some aspects, the at least one quantity may indicate for the base station (and UE) to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to an MPE event. For example, referring to FIG. 7, the base station 704 may receive, and the UE 702 may transmit (or report), a TER 710 that includes at least one quantity that may indicate for the base station (or UE), e.g., based on detecting 714 (or 718), to adjust the UL transmission characteristic.

At 1404, the base station may adjust at least one parameter associated with the UL transmission, based on the at least one quantity reported by the UE (e.g., received at 1402 by the base station) indicating for the base station to adjust the UL transmission characteristic and a set of rules associated with the UL transmission. For example, 1404 may be performed by implicit adjustment component 1742. For example, referring to FIG. 7, the base station 704 may adjust 720 at least one parameter associated with the UL transmission based on the at least one quantity reported to the base station, e.g., via TER 710, indicating for the base station (or UE) to adjust the UL transmission characteristic, e.g., based on detecting 714.

In some aspects, adjusting the at least one parameter associated with the UL transmission occurs at one of a first configured time after an ACK is transmitted from the base station regarding the at least one reported quantity or a second configured time after a reception time of a report including the at least one reported quantity. The configured time after the ACK transmission or the configured time after the reception time of the report including the at least one reported quantity, in some aspects, may be indicated based on at least one of microseconds, milliseconds, seconds, minutes, symbols, slots, subframes, or frames. In some aspects, adjusting the at least one parameter includes adjusting at least one of a bandwidth of a frequency domain resource allocation, a number of symbols in a time domain resource allocation, a modulation and coding scheme, a DMRS density, a number of repetitions, a periodicity of a CG, an expected transmission power, dropping transmissions associated with a CG-PUSCH, prioritizing resources associated with a CG-PUSCH, or an activation of resources associated with a CG-PUSCH.

The set of rules associated with the UL transmission, in some aspects, includes a set of priority rules relating to a plurality of CG-PUSCH resources. A magnitude of the adjustment to the at least one parameter, in some aspects, may be based on a priority of at least one of the plurality of CG-PUSCH. In some aspects, a first magnitude of the adjustment to the at least one parameter may be based on at least one of an absolute value of the at least one reported quantity, a second magnitude of the increase of the at least one reported quantity, a third magnitude of the decrease of the at least one reported quantity, or a difference between the at least one reported quantity and an associated threshold. Adjusting the at least one parameter associated with the UL transmission, in some aspects, includes adjusting at least one parameter associated with transmission of a periodic CSI, where the at least one parameter includes at least one of a reporting periodicity, a modulation coding scheme, or a beta-offset for CSI. In some aspects, adjusting the at least one parameter associated with the UL transmission includes adjusting at least one parameter associated with transmission of at least one of a P-SRS or a SPS-SRS, and the at least one parameter includes at least one of a bandwidth of a frequency domain resource allocation, a number of repetitions, a time-domain periodicity of the SRS, a frequency-hopping offset, a density of the SRS in a frequency domain, a transmission power, dropping transmissions associated with a P-SRS configuration, prioritizing resources associated with a P-SRS configuration, or an activation of resources associated with a P-SRS configuration.

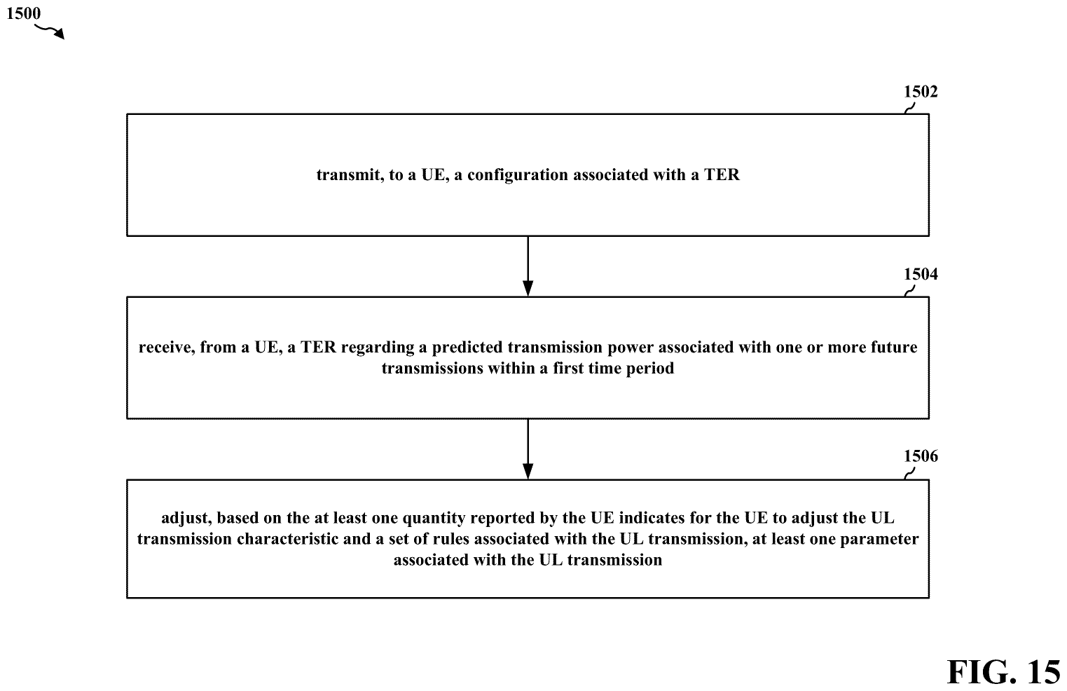

FIG. 15 is a flowchart 1500 of a method of wireless communication. The method may be performed by a base station (e.g., the base station 102/180 or 704; the apparatus 1702). At 1502, the base station may transmit, and a UE may receive, a configuration associated with a TER. For example, 1502 may be performed by transmission energy report configuration component 1740. The configuration associated with the TER may include a configuration of a first time period. The configuration of the first time period, in some aspects, includes one of a first length of a first, previous time subperiod, a second length of a second, subsequent time subperiod, and a third length of time between the first, previous time subperiod and the second, subsequent time subperiod, where the first length of time, the second length of time, and the third length of time is one of a preconfigured length of time or a length of time configured by a transmission from a base station. In some aspects, the configuration includes an indication of at least one reference time, the at least one reference time including at least one of a beginning of the first, previous time subperiod, an end of the first, previous time subperiod, a beginning of the second, subsequent time subperiod, or an end of the second, subsequent time subperiod. The at least one reference time, in some aspects, may be indicated based on one of a symbol, slot, subframe, a frame, or a reference time. In some aspects, the configuration of the first time period is one of, preconfigured, configured by the base station, or determined by the UE.

The configuration, in some aspects, may further include an indication of at least one of a first threshold value associated with an increase in a reported value, a second threshold value associated with a decrease in a reported value, a third threshold (maximum) value associated with a reported value, a fourth threshold (minimum) value associated with a reported value, or a criterion associated with a reported quantity being related to a maximum permissible exposure event. In some aspects, the configuration associated with the TER may be transmitted from the base station via one of an RRC transmission, a MAC-CE, or a UCI. The configuration, in some aspects, may be transmitted based on at least one of a configured periodicity or a dynamic indication from the base station. For example, referring to FIG. 7, the base station 704 may transmit, and the UE 702 may receive, a TER configuration 706.

At 1504, the base station may receive, from a UE, a TER regarding a predicted transmission power associated with one or more future transmissions within a first time period. The TER may be received based on a configuration that is one of known to the UE and the base station (e.g., pre-configured), transmitted at 1502 to the UE, or determined by the UE. For example, 1504 may be performed by implicit adjustment component 1742. As described above in reference to FIG. 7, the base station 704 may receive TER 710.

Finally, at 1506, the base station may adjust at least one parameter associated with the UL transmission, based on the at least one quantity reported by the UE (e.g., received at 1502 by the base station) indicating for the base station to adjust the UL transmission characteristic and a set of rules associated with the UL transmission. For example, 1506 may be performed by implicit adjustment component 1742. Adjusting the at least one parameter associated with the UL transmission, in some aspects, may be further based on a transmission from the base station. The transmission from the base station, in some aspects, may include at least one of a MAC-CE or a DCI that indicates one configuration of a plurality of configurations received via an RRC from the base station. For example, referring to FIG. 7, the UE 702 may adjust 720 based on the at least one quantity reported to the base station, e.g., via TER 710, indicating for the UE to adjust the UL transmission characteristic.

In some aspects, adjusting the at least one parameter associated with the UL transmission occurs at one of a first configured time after an ACK is received at the UE regarding the at least one reported quantity or a second configured time after a transmission time of a report including the at least one reported quantity. The configured time after the ACK or the configured time after the transmission time of the report including the at least one reported quantity may be indicated based on at least one of microseconds, milliseconds, seconds, minutes, symbols, slots, subframes, or frames. In some aspects, adjusting the at least one parameter includes adjusting at least one of a bandwidth of a frequency domain resource allocation, a number of symbols in a time domain resource allocation, a modulation and coding scheme, a DMRS density, a number of repetitions, a periodicity of a CG, a transmission power, dropping transmissions associated with a CG-PUSCH, prioritizing resources associated with a CG-PUSCH, or an activation of resources associated with a CG-PUSCH.

The set of rules associated with the UL transmission, in some aspects, includes a set of priority rules relating to a plurality of CG-PUSCH resources. A magnitude of the adjustment to the at least one parameter, in some aspects, may be based on a priority of at least one of the plurality of CG-PUSCH. In some aspects, a first magnitude of the adjustment to the at least one parameter may be based on at least one of an absolute value of the at least one reported quantity, a second magnitude of the increase of the at least one reported quantity, a third magnitude of the decrease of the at least one reported quantity, or a difference between the at least one reported quantity and an associated threshold. Adjusting the at least one parameter associated with the UL transmission, in some aspects, includes adjusting at least one parameter associated with transmission of a periodic CSI, where the at least one parameter includes at least one of a reporting periodicity, a modulation coding scheme, or a beta-offset for CSI. In some aspects, adjusting the at least one parameter associated with the UL transmission includes adjusting at least one parameter associated with transmission of at least one of a P-SRS or a SPS-SRS, and the at least one parameter includes at least one of a bandwidth of a frequency domain resource allocation, a number of repetitions, a time-domain periodicity of the SRS, a frequency-hopping offset, a density of the SRS in a frequency domain, a transmission power, or an activation of resources associated with a P-SRS configuration.

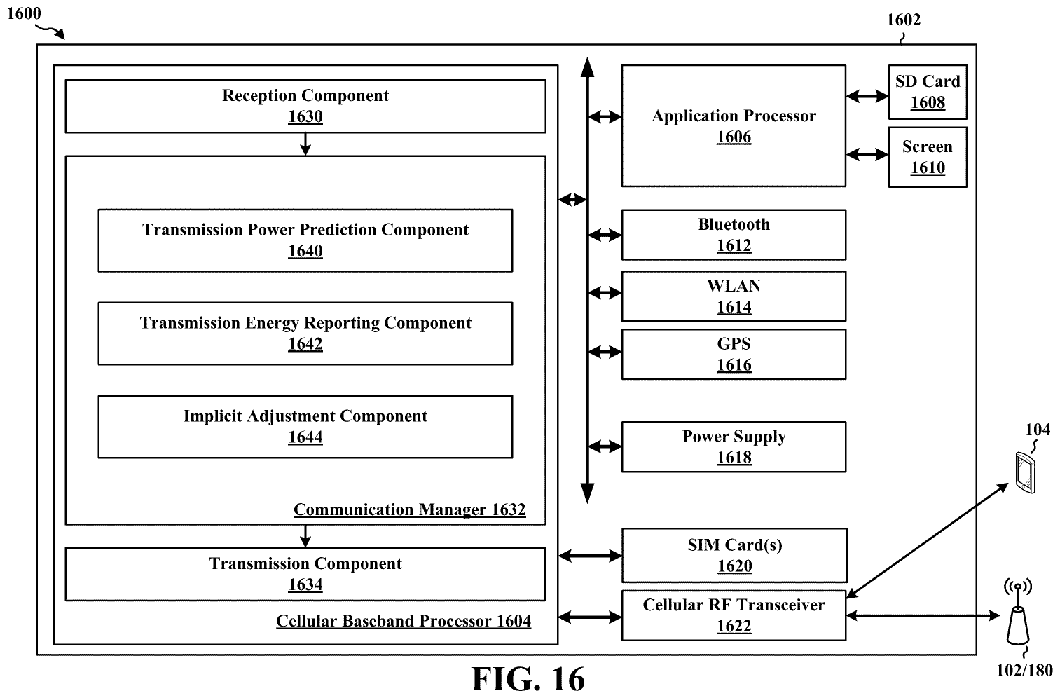

FIG. 16 is a diagram 1600 illustrating an example of a hardware implementation for an apparatus 1602. The apparatus 1602 may be a UE, a component of a UE, or may implement UE functionality. In some aspects, the apparatus 1602 may include a cellular baseband processor 1604 (also referred to as a modem) coupled to a cellular RF transceiver 1622. In some aspects, the apparatus 1602 may further include one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, or a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The communication manager 1632 includes a transmission power prediction component 1640 that is configured to receive a configuration associated with a TER and/or calculate a predicted transmission power associated with one or more future transmissions within a first time period, e.g., as described in connection with 1102, 1202, and 1204 of FIGS. 11 and 12. The communication manager 1632 further includes a transmission energy reporting component 1642 that receives input in the form of the calculated, predicted transmission power from the component 1640 and is configured to transmit a TER regarding the predicted transmission power to a base station, transmit a preserved transmission power report indicating a value for a maximum output power associated with at least one of the one or more future transmissions within the first time period to the base station, transmit at least one additional report relating to at least one of (1) an MPE associated with at least one of the one or more future transmissions within the first time period or (2) at least one of a minimum P-MPR value, a maximum P-MPR value, or an average P-MPR value associated with at least one of the one or more future transmissions within the first time period to the base station, e.g., as described in connection with 1104, 1206, 1208, 1210, 1212, 1302 of FIGS. 11, 12, and 13. The communication manager 1632 further includes an implicit adjustment component 1644 that receives input in the form of a calculated, predicted transmission power from the component 1640 and is configured to adjust, based on the at least one quantity reported to the base station indicating for the UE to adjust the UL transmission characteristic and a set of rules associated with the UL transmission, at least one parameter associated with the UL transmission, e.g., as described in connection with 1304 of FIG. 13.

The apparatus may include additional components that perform each of the blocks of the algorithm in the flowcharts of FIGS. 11-13. As such, each block in the flowcharts of FIGS. 11-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1602 may include a variety of components configured for various functions. In one configuration, the apparatus 1602, and in particular the cellular baseband processor 1604, includes means for calculating a predicted transmission power associated with one or more future transmissions within a first time period. The apparatus 1602, and in particular the cellular baseband processor 1604, may further include means for transmitting, to a base station, a TER regarding the predicted transmission power. The apparatus 1602, and in particular the cellular baseband processor 1604, may further include means for transmitting, to the base station, a subsequent TER regarding an additional predicted transmission power associated with one or more additional future transmissions within a second time period, where a time between a beginning of the first time period and a beginning of the second time period is based on at least one of a value known by the UE, a configuration received from the base station, or a beginning of a transmission including the subsequent TER associated with the second time period. The apparatus 1602, and in particular the cellular baseband processor 1604, may further include means for transmitting a preserved transmission power report indicating a value for a maximum output power associated with at least one of the one or more future transmissions within the first time period, where the value for the maximum output power is based on the predicted transmission power. The apparatus 1602, and in particular the cellular baseband processor 1604, may further include means for transmitting at least one additional report relating to at least one of (1) an MPE associated with at least one of the one or more future transmissions within the first time period or (2) at least one of a minimum P-MPR value, a maximum P-MPR value, or an average P-MPR value associated with at least one of the one or more future transmissions within the first time period. The apparatus 1602, and in particular the cellular baseband processor 1604, may further include means for reporting at least one quantity to a base station, the at least one quantity indicating for the UE to adjust an UL transmission characteristic, where the at least one quantity indicates for the UE to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to a maximum permissible exposure event. The apparatus 1602, and in particular the cellular baseband processor 1604, may further include means for adjusting, based on the at least one quantity reported to the base station indicating for the UE to adjust the UL transmission characteristic and a set of rules associated with the UL transmission, at least one parameter associated with the UL transmission. The apparatus 1602, and in particular the cellular baseband processor 1604, may further include means for receiving a configuration associated with a TER. The means may be one or more of the components of the apparatus 1602 configured to perform the functions recited by the means. As described supra, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

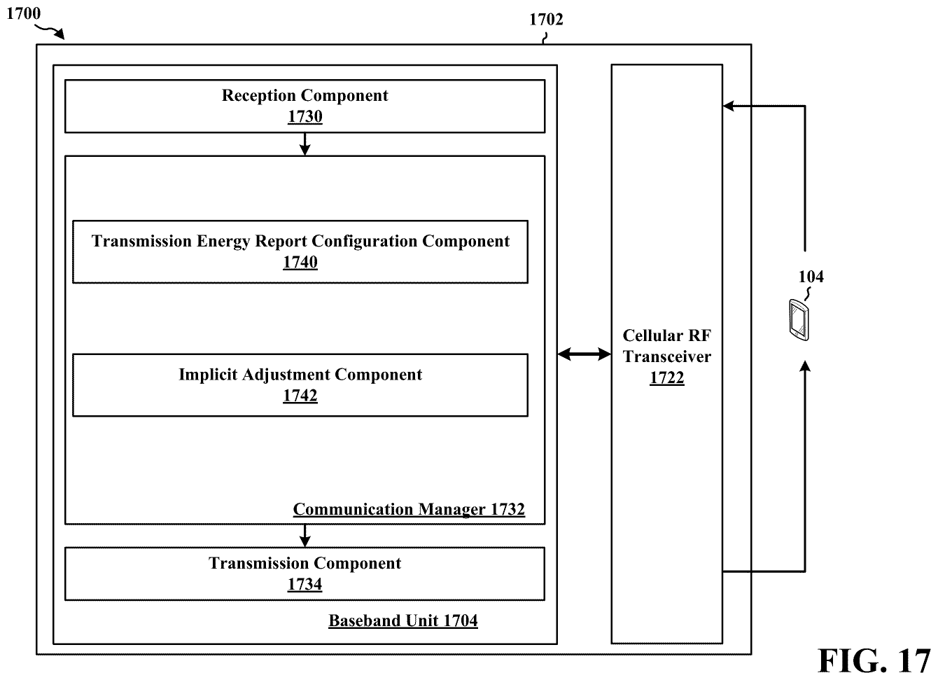

FIG. 17 is a diagram 1700 illustrating an example of a hardware implementation for an apparatus 1702. The apparatus 1702 may be a base station, a component of a base station, or may implement base station functionality. In some aspects, the apparatus 1602 may include a baseband unit 1704. The baseband unit 1704 may communicate through a cellular RF transceiver 1722 with the UE 104. The baseband unit 1704 may include a computer-readable medium/memory. The baseband unit 1704 is responsible for general processing, including the execution of software stored on the computer-readable medium/memory. The software, when executed by the baseband unit 1704, causes the baseband unit 1704 to perform the various functions described supra. The computer-readable medium/memory may also be used for storing data that is manipulated by the baseband unit 1704 when executing software. The baseband unit 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the baseband unit 1704. The baseband unit 1704 may be a component of the base station 310 and may include the memory 376 and/or at least one of the TX processor 316, the RX processor 370, and the controller/processor 375.

The communication manager 1732 includes a transmission energy report configuration component 1740 that may transmit a configuration associated with a TER to a UE, e.g., as described in connection with 1502. The communication manager 1732 further includes an implicit adjustment component 1742 that may be configured to receive at least one quantity reported by a UE to adjust an UL transmission characteristic; indicate, to the UE, a transmission power based on the TER received from the UE; adjust at least one parameter associated with the UL transmission, based on the at least one quantity reported by the UE indicating for the base station to adjust the UL transmission characteristic and a set of rules associated with the UL transmission, e.g., as described in connection with 1402, 1404, 1504, and 1506 of FIGS. 14 and 15.

The apparatus may include additional components that perform each of the blocks of the algorithm in the flowcharts of FIGS. 14 and 15. As such, each block in the flowcharts of FIGS. 14 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the baseband unit 1704, includes means for receiving, from a UE, a TER regarding a predicted transmission power associated with one or more future transmissions within a first time period. The apparatus 1702, and in particular the baseband unit 1704, may further include means for indicating a transmission power to the UE based on the TER received from the UE. The apparatus 1702, and in particular the baseband unit 1704, may further include means for transmitting, to a UE, a configuration associated with a TER. The apparatus 1702, and in particular the baseband unit 1704, may further include means for receiving at least one quantity reported by a UE to adjust an UL transmission characteristic. The apparatus 1702, and in particular the baseband unit 1704, may further include means for adjusting at least one parameter associated with the UL transmission. The means may be one or more of the components of the apparatus 1702 configured to perform the functions recited by the means. As described supra, the apparatus 1702 may include the TX Processor 316, the RX Processor 370, and the controller/processor 375. As such, in one configuration, the means may be the TX Processor 316, the RX Processor 370, and the controller/processor 375 configured to perform the functions recited by the means.

In some aspects of wireless communication, a historical power consumption and a remaining power budget over time windows are unavailable at a base station. The lack of such information at the base station may lead to performance degradation or greater overhead. The performance degradation and greater overhead may be especially problematic for CG-PUSCH and/or a P-CSI report. Aspects presented herein provide for enhancing information reported from a UE to improve information available for a base station which can be used to improve performance related to CG-PUSCH and/or P-CSI report through more accurate scheduling and may further reduce overhead associated with the CG-PUSCH and P-CSI.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to calculate a predicted transmission power associated with one or more future transmissions within a first time period; and transmit, to a base station, a TER regarding the predicted transmission power.

Aspect 2 is the apparatus of aspect 1, where the first time period includes a first, previous time subperiod associated with a measured transmission power of a set of zero or more transmissions during the first, previous time subperiod and a second, subsequent time subperiod that is associated with the one or more future transmissions, and the TER relates to the measured transmission power and the predicted transmission power.

Aspect 3 is the apparatus of aspect 2, where the TER related to the measured transmission power and the predicted transmission power comprises a measured transmission energy and a predicted transmission energy, where the measured transmission energy is based on a duration of the first, previous time subperiod and the measured transmission power and the predicted transmission energy is based on a duration of the second, subsequent time subperiod and the predicted transmission power.

Aspect 4 is the apparatus of aspect 3, where the TER relates to at least one of an average transmission power over the first time period or a maximum transmission power over the first time period for at least one of the measured transmission power or the predicted transmission power.

Aspect 5 is the apparatus of any of aspects 2 to 4, where a configuration of the first time period includes one of a first length of the first, previous time subperiod, a second length of the second, subsequent time subperiod, and a third length of time between the first, previous time subperiod and the second, subsequent time subperiod, where the first length of time, the second length of time, and the third length of time are one of a known length of time or a length of time received from the base station, and where the configuration further includes an indication of at least one reference time, the at least one reference time including at least one of a beginning of the first, previous time subperiod, an end of the first, previous time subperiod, a beginning of the second, subsequent time subperiod, or an end of the second, subsequent time subperiod.

Aspect 6 is the apparatus of aspect 5, where the at least one reference time is indicated based on one of a symbol, slot, subframe, a frame, or a reference time.

Aspect 7 is the apparatus of any of aspects 5 and 6, where the configuration of the first time period is one of known by the UE, received from the base station, or determined by the UE.

Aspect 8 is the apparatus of any of aspects 1 to 7, the at least one processor further configured to transmit, to the base station, a subsequent TER regarding an additional predicted transmission power associated with one or more additional future transmissions within a second time period, where a time between a beginning of the first time period and a beginning of the second time period is based on at least one of a value known by the UE, a configuration received from the base station, or a beginning of a transmission including the subsequent TER associated with the second time period.

Aspect 9 is the apparatus of any of aspects 1 to 8, the at least one processor further configured to transmit a preserved transmission power report indicating a value for a maximum output power associated with at least one of the one or more future transmissions within the first time period, where the value for the maximum output power is based on the predicted transmission power.

Aspect 10 is the apparatus of any of aspects 1 to 9, the at least one processor further configured to transmit at least one additional report relating to at least one of (1) an MPE associated with at least one of the one or more future transmissions within the first time period or (2) at least one of a minimum P-MPR value, a maximum P-MPR value, or an average P-MPR value associated with at least one of the one or more future transmissions within the first time period.

Aspect 11 is the apparatus of any of aspects 1 to 10, where the TER regarding the predicted transmission power includes a report for a set of two or more time subperiods.

Aspect 12 is the apparatus of aspect 11, where the set of two or more time subperiods include time subperiods of different lengths.

Aspect 13 is the apparatus of any of aspects 1 to 12, where the at least one processor is configured to calculate the predicted transmission power by calculating the predicted transmission power based on a duty cycle of uplink transmissions.

Aspect 14 is the apparatus of any of aspects 1 to 14, further including a transceiver coupled to the at least one processor.

Aspect 15 is an apparatus for wireless communication including at least one processor coupled to a memory and configured to report at least one quantity to a base station, the at least one quantity indicating for the UE to adjust an UL transmission characteristic, where the at least one quantity indicates for the UE to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to a maximum permissible exposure event; and adjust, based on the at least one quantity reported to the base station indicating for the UE to adjust the UL transmission characteristic and a set of rules associated with the UL transmission, at least one parameter associated with the UL transmission.

Aspect 16 is the apparatus of aspect 15, where the UL transmission includes one of a periodic UL transmission or a semi-persistent scheduling UL transmission.

Aspect 17 is the apparatus of any of aspects 15 and 16, where the at least one processor is configured to adjust the at least one parameter associated with the UL transmission at one of a first configured time after an ACK is received at the UE regarding the at least one reported quantity or a second configured time after a transmission time of a report including the at least one reported quantity.

Aspect 18 is the apparatus of aspect 17, where the configured time after the ACK or the configured time after the transmission time of the report including the at least one reported quantity is indicated based on at least one of microseconds, milliseconds, seconds, minutes, symbols, slots, subframes, or frames.

Aspect 19 is the apparatus of any of aspects 15 to 18, where the at least one parameter includes at least one of a bandwidth of a frequency domain resource allocation, a number of symbols in a time domain resource allocation, a modulation and coding scheme, a DMRS density, a number of repetitions, a periodicity of a CG, a transmission power, dropping transmissions associated with a CG-physical uplink shared channel (PUSCH), or prioritizing resources associated with a CG-PUSCH.

Aspect 20 is the apparatus of any of aspects 15 to 19, where the set of rules associated with the UL transmission includes a set of priority rules relating to a plurality of CG-PUSCH resources and a magnitude of the adjustment to the at least one parameter is based on a priority of at least one of the plurality of CG-PUSCH.

Aspect 21 is the apparatus of any of aspects 15 to 20, where a first magnitude of the adjustment to the at least one parameter is based on at least one of an absolute value of the at least one reported quantity, a second magnitude of the increase of the at least one reported quantity, a third magnitude of the decrease of the at least one reported quantity, or a difference between the at least one reported quantity and an associated threshold.

Aspect 22 is the apparatus of any of aspects 15 to 21, where the at least one parameter associated with the UL transmission includes at least one parameter associated with transmission of a periodic CSI, where the at least one parameter includes at least one of a reporting periodicity, a modulation coding scheme, or a beta-offset for CSI.

Aspect 23 is the apparatus of any of aspects 15 to 22, where the at least one parameter associated with the UL transmission includes at least one parameter associated with transmission of at least one of a P-SRS or a SPS-SRS, and the at least one parameter includes at least one of a bandwidth of a frequency domain resource allocation, a number of repetitions, a time-domain periodicity of the SRS, a frequency-hopping offset, a density of the SRS in a frequency domain, a transmission power, or an activation of resources associated with a P-SRS configuration.

Aspect 24 is the apparatus of any of aspects 15 to 23, further including a transceiver coupled to the at least one processor, where the at least one processor is configured to adjust the at least one parameter associated with the UL transmission based on a transmission from the base station.

Aspect 25 is the apparatus of aspect 24, where the transmission from the base station includes at least one of a MAC-CE or a DCI that indicates one configuration of a plurality of configurations received via an RRC from the base station.

Aspect 26 is the apparatus of any of aspects 15 to 25, where the reported at least one quantity comprises at least one of a transmission energy associated with a previous time period, an average transmission power associated with the previous time period, an estimated maximum transmission energy associated with a subsequent time period, an average transmission power associated with the subsequent time period, a preserved transmission power level, a duration of an MPE event, a P-MPR value, a time duration associated with the P-MPR value.

Aspect 27 is an apparatus for wireless communication including at least one processor coupled to a memory and configured to receive at least one quantity reported by a UE to adjust an UL transmission characteristic, where the at least one quantity indicates to adjust the UL transmission characteristic based on at least one of an increase of a reported quantity that is greater than a first threshold increase value, a decrease of the reported quantity that is greater than a second threshold decrease, the reported quantity being larger than a third threshold value, the reported quantity being lower than a fourth threshold value, or the reported quantity being related to a maximum permissible exposure event; and adjust at least one parameter associated with the UL transmission, the adjusting being based on the at least one quantity reported by the UE indicates for the UE to adjust the UL transmission characteristic and a set of rules associated with the UL transmission.

Aspect 28 is the apparatus of aspect 27, further including a transceiver coupled to the at least one processor, the at least one processor further configured to transmit, to the UE, a configuration associated with reporting the at least one quantity, wherein the configuration includes at least one of a first length of a first, previous time subperiod, a second length of a second, subsequent time subperiod, and a third length of time between the first, previous time subperiod and the second, subsequent time subperiod, the configuration further including an indication of at least one of the first threshold increase value, the second threshold decrease value, the third threshold value, the fourth threshold value, or the reported quantity being related to an MPE event.

Aspect 29 is the apparatus of any of aspects 27 and 28, where the reported at least one quantity includes at least one of a transmission energy associated with a previous time period, an average transmission power associated with the previous time period, an estimated maximum transmission energy associated with a subsequent time period, an average transmission power associated with the subsequent time period, a preserved transmission power level, a duration of an MPE event, a P-MPR value, a time duration associated with the P-MPR value.

Aspect 30 is a method of wireless communication for implementing any of aspects 1 to 29.

Aspect 31 is an apparatus for wireless communication including means for implementing any of aspects 1 to 29.

Aspect 32 is a computer-readable medium storing computer executable code, where the code when executed by a processor causes the processor to implement any of aspects 1 to 29.

What is claimed is:

1. An apparatus for wireless communication at a user equipment (UE), comprising:
a memory; and
at least one processor coupled to the memory and configured to:
calculate a predicted transmission power associated with one or more future transmissions within a first time period; and
transmit, to a base station, a transmit energy report (TER) regarding the predicted transmission power.

2. The apparatus of claim 1, wherein the first time period comprises a first, previous time subperiod associated with a measured transmission power of a set of zero or more transmissions during the first, previous time subperiod and a second, subsequent time subperiod that is associated with the one or more future transmissions, and the TER relates to the measured transmission power and the predicted transmission power.

3. The apparatus of claim 2, wherein the TER related to the measured transmission power and the predicted transmission power comprises a measured transmission energy and a predicted transmission energy, where the measured transmission energy is based on a first duration of the first, previous time subperiod and the measured transmission power and the predicted transmission energy is based on a second duration of the second, subsequent time subperiod and the predicted transmission power.

4. The apparatus of claim 3, wherein the TER relates to at least one of an average transmission power over the first time period or a maximum transmission power over the first time period for at least one of the measured transmission power or the predicted transmission power.

5. The apparatus of claim 2,
wherein a configuration of the first time period comprises one of a first length of the first, previous time subperiod, a second length of the second, subsequent time subperiod, and a third length of time between the first, previous time subperiod and the second, subsequent time subperiod, wherein the first length of time, the second length of time, and the third length of time are one of a known length of time or a length of time received from the base station, and
wherein the configuration further comprises an indication of at least one reference time, the at least one reference time comprising at least one of a beginning of the first, previous time subperiod, an end of the first, previous time subperiod, a beginning of the second, subsequent time subperiod, or an end of the second, subsequent time subperiod.

6. The apparatus of claim 5, wherein the at least one reference time is indicated based on one of a symbol, slot, subframe, a frame, or a reference time.

7. The apparatus of claim 5, wherein the configuration of the first time period is one of known by the UE, received from the base station, or determined by the UE.

8. The apparatus of claim 1, the at least one processor further configured to:
transmit, to the base station, a subsequent TER regarding an additional predicted transmission power associated with one or more additional future transmissions within a second time period, wherein a time between a beginning of the first time period and a beginning of the second time period is based on at least one of a value known by the UE, a configuration received from the base station, or a beginning of a transmission comprising the subsequent TER associated with the second time period.

9. The apparatus of claim 1, the at least one processor further configured to:
transmit a preserved transmission power report indicating a value for a maximum output power associated with at least one of the one or more future transmissions within the first time period, wherein the value for the maximum output power is based on the predicted transmission power.

10. The apparatus of claim 1, the at least one processor further configured to:
transmit at least one additional report relating to at least one of (1) a maximum permissible exposure (MPE) associated with at least one of the one or more future transmissions within the first time period or (2) at least one of a minimum power management maximum power reduction (P-MPR) value, a maximum P-MPR value, or an average P-MPR value associated with at least one of the one or more future transmissions within the first time period.

11. The apparatus of claim 1, wherein the TER regarding the predicted transmission power comprises a report for a set of two or more time subperiods.

12. The apparatus of claim 11, wherein the set of two or more time subperiods comprise time subperiods of different lengths.

13. The apparatus of claim 1, wherein the at least one processor is configured to calculate the predicted transmission power by calculating the predicted transmission power based on a duty cycle of uplink transmissions.

14. The apparatus of claim 1, further comprising a transceiver coupled to the at least one processor.

15. An apparatus for wireless communication at a first user equipment (UE) comprising:
a memory; and
at least one processor coupled to the memory and configured to:
report at least one quantity to a base station, the at least one quantity indicating for the UE to adjust an uplink (UL) transmission characteristic, wherein the at least one quantity indicates for the UE to adjust the UL transmission characteristic based on at least one of an increase of a reported quantity that is greater than a first threshold increase value, a decrease of the reported quantity that is greater than a second threshold decrease value, the reported quantity being greater than a third threshold value, the reported quantity being less than a fourth threshold value, or the reported quantity being related to a maximum permissible exposure event; and
adjust, based on the at least one quantity reported to the base station indicating for the UE to adjust the UL transmission characteristic and a set of rules associated with an UL transmission, at least one parameter associated with the UL transmission.

16. The apparatus of claim 15, wherein the UL transmission comprises one of a periodic UL transmission or a semi-persistent scheduling UL transmission.

17. The apparatus of claim 15, wherein the at least one processor is configured to adjust the at least one parameter associated with the UL transmission at one of a first configured time after an acknowledgement (ACK) is received at the UE regarding the at least one reported quantity or a second configured time after a transmission time of a report including the at least one reported quantity.

18. The apparatus of claim 17, wherein the first configured time after the ACK or the second configured time after the transmission time of the report including the at least one reported quantity is indicated based on at least one of microseconds, milliseconds, seconds, minutes, symbols, slots, subframes, or frames.

19. The apparatus of claim 15, wherein the at least one parameter comprises at least one of a bandwidth of a frequency domain resource allocation, a number of symbols in a time domain resource allocation, a modulation and coding scheme, a demodulation reference signal (DMRS) density, a number of repetitions, a periodicity of a configured grant (CG), a transmission power, dropping transmissions associated with a CG-physical uplink shared channel (PUSCH), or prioritizing resources associated with a CG-PUSCH.

20. The apparatus of claim 15, wherein the set of rules associated with the UL transmission comprises a set of priority rules relating to a plurality of configured grant (CG) physical uplink shared channel (PUSCH) resources and a magnitude of an adjustment to the at least one parameter is based on a priority of at least one of the plurality of CG-PUSCH.

21. The apparatus of claim 15, wherein a first magnitude of an adjustment to the at least one parameter is based on at least one of an absolute value of the at least one reported quantity, a second magnitude of the increase of the at least one reported quantity, a third magnitude of the decrease of the at least one reported quantity, or a difference between the at least one reported quantity and an associated threshold.

22. The apparatus of claim 15, wherein the at least one parameter associated with the UL transmission comprises one or more parameter associated with transmission of a periodic channel state information (CSI), wherein the at least one parameter comprises at least one of a reporting periodicity, a modulation coding scheme, or a beta-offset for CSI.

23. The apparatus of claim 15, wherein the at least one parameter associated with the UL transmission comprises one or more parameter associated with transmission of at least one of a periodic (P) sounding reference signal (SRS) (P-SRS) or a semi-persistent scheduling (SPS)-SRS, and the at least one parameter comprises at least one of a bandwidth of a frequency domain resource allocation, a number of repetitions, a time-domain periodicity of the SRS, a frequency-hopping offset, a density of the SRS in a frequency domain, a transmission power, or an activation of resources associated with a P-SRS configuration.

24. The apparatus of claim 15, further comprising a transceiver coupled to the at least one processor, wherein the at least one processor is configured to adjust the at least one parameter associated with the UL transmission based on a transmission from the base station.

25. The apparatus of claim 24, wherein the transmission from the base station comprises at least one of a media access control (MAC) control element (CE) (MAC-CE) or a downlink control information (DCI) that indicates one configuration of a plurality of configurations received via a radio resource control (RRC) from the base station.

26. The apparatus of claim 15, wherein the reported at least one quantity comprises at least one of a transmission energy associated with a previous time period, a first average transmission power associated with the previous time period, an estimated maximum transmission energy associated with a subsequent time period, a second average transmission power associated with the subsequent time period, a preserved transmission power level, a duration of the maximum permissible exposure event, a power management maximum power reduction (P-MPR) value, a time duration associated with the P-MPR value.

27. An apparatus for wireless communication comprising:
a memory; and
at least one processor coupled to the memory and configured to:
receive at least one quantity reported by a user equipment (UE) to adjust an uplink (UL) transmission characteristic, wherein the at least one quantity indicates to adjust the UL transmission characteristic based on at least one of an increase of a reported quantity that is greater than a first threshold increase value, a decrease of the reported quantity that is greater than a second threshold decrease value, the reported quantity being larger than a third threshold value, the reported quantity being lower than a fourth threshold value, or the reported quantity being related to a maximum permissible exposure event; and
adjust at least one parameter associated with an UL transmission based on the at least one quantity reported by the UE indicates for the UE to adjust the UL transmission characteristic and a set of rules associated with the UL transmission.

28. The apparatus of claim 27, further comprising a transceiver coupled to the at least one processor, the at least one processor further configured to:
transmit, to the UE, a configuration associated with reporting the at least one quantity, wherein the configuration comprises at least one of a first length of a first, previous time subperiod, a second length of a second, subsequent time subperiod, and a third length of time between the first, previous time subperiod and the second, subsequent time subperiod, the configuration further comprising an indication of at least one of the first threshold increase value, the second threshold decrease value, the third threshold value, the fourth threshold value, or the reported quantity being related to the maximum permissible exposure event.

29. The apparatus of claim 27, wherein the reported at least one quantity comprises at least one of a transmission energy associated with a previous time period, a first average transmission power associated with the previous time period, an estimated maximum transmission energy associated with a subsequent time period, a second average transmission power associated with the subsequent time period, a preserved transmission power level, a duration of the maximum permissible exposure event, a power management maximum power reduction (P-MPR) value, a time duration associated with the P-MPR value.

30. A method of wireless communication at a user equipment (UE) comprising:
calculating a predicted transmission power associated with one or more future transmissions within a first time period; and
transmitting, to a base station, a transmit energy report (TER) regarding the predicted transmission power.
